(19) United States
(12) Patent Application Publication
(10) Pub. No.: US 2017/0336073 A1
(43) Pub. Date: Nov. 23, 2017

(54) METHOD AND APPARATUS FOR AVOIDING FROST OR ICE BUILD-UP ON EXHAUST VENTS AND AIR INTAKES OF CONDENSING APPLIANCES

(71) Applicant: FROSTFREE VENTING INC., Calgary (CA)

(72) Inventors: Lesley WEIR, Calgary (CA); Kevin WERT, Wilmington, DE (US)

(21) Appl. No.: 15/531,301

(22) PCT Filed: Nov. 29, 2015
(86) PCT No.: PCT/CA2015/051243

§ 371 Date: May 26, 2017

Related U.S. Application Data
(60) Provisional application No. 62/085,388, filed on Nov. 28, 2014.
(60) Provisional application No. 62/244,276, filed on Oct. 21, 2015.

(51) Int. Cl. F23L 17/04; F16L 53/00; F23L 15/04; F28F 1/10; F23J 13/06; F23J 15/06

(52) U.S. Cl. CPC F23L 17/04; F23J 13/06; F23J 15/06; F23L 15/045; F28F 1/10; F16L 53/001; F23J 2211/30; F23J 2900/13006; F28F 2215/02; F23J 2213/50

(57) ABSTRACT

Described herein is an apparatus and method for avoiding frost buildup on the air intake and or ice buildup on the ice condensing surfaces of the exhaust vent of a condensing appliance. The apparatus comprises a heat-conducting path that extends between the exhaust gas in the exhaust vent of the appliance, and the frost condensing surfaces at or near the air intake opening of the combustion air vent. The heat-conducting path has a first section in thermal contact with the exhaust gas and a second section in thermal contact with the frost condensing surfaces at or near the air intake. In one configuration, the heat-conducting path is a heat pipe. In one configuration the heat-conducting path is a heat exchanger assembly. The passive transfer of heat energy via the heat-conducting path, from the exhaust gas to the frost condensing surfaces at or near the air intake, avoids frost buildup.

### FIELD

A product and method for avoiding or preventing the accumulation of frost or ice on the combustion air intake or piping of a condensing fired appliance, and on the exhaust vent terminus or a redirection fitting thereon.

### BACKGROUND

Combustion appliances burn fuels for heating, cooking, or decorative purposes. Examples of combustion appliances include boilers, furnaces and water heaters. Combustion, or burning, is a high-temperature exothermic chemical reaction between a fuel and an oxidant, which in the case of combustion appliances is atmospheric oxidant. Common fuels used by these appliances are natural or liquefied petroleum gas and fuel oil.

The gaseous product of combustion is comprised primarily of water vapor, carbon dioxide and heat, and also harmful compounds such as carbon monoxide and nitrogen dioxide. It is desirable to vent this gaseous product to the outside atmosphere of a building or house (hereafter “building”), which is why combustion appliances all have flues (ducts or pipes) which dispose the combustion product to the outside atmosphere. Further, since the combustion process requires oxygen, all combustion appliances require a source of fresh air. Air can be obtained either from the environment immediately around the appliance inside the building, or from an air intake that is ducted from the outside atmosphere of the building to the appliance

High efficiency combustion appliances, known as “condensing” appliances, extract additional heat from the gaseous combustion product before it is released to the outside atmosphere, by condensing the water vapour in the gas to liquid water, thus recovering its latent heat of vaporization. An exhaust gas of lower temperature is then vented to the outside. Condensing appliances range in efficiency from 83% to 98%, thus a typical increase of efficiency in a condensing appliance over a non-condensing appliance can be as much as 10-15%.

Traditional (i.e., non-condensing) combustion appliances were vented through the roof, as the buoyancy of the hot combustion gas could be relied upon to move the gas up through a chimney flue and out of the building. However, because so much heat is removed from the combustion gas of condensing appliances, the gas has a lower-temperature and these appliances must use forced venting systems to ensure proper exhaust gas flow. Because of this forced venting and water condensation, high-efficiency appliances cannot use a natural draft chimney. All condensing appliances must be individually vented in North America, and can be vented through the sidewall of a building, or through the roof. In Europe group venting of appliances is practiced.

Commonly, two conduits are installed for each condensing appliance; an “exhaust” vent for venting of exhaust gas to the outside atmosphere and an “air intake” for intake of fresh combustion air from the outside atmosphere, to be used in the combustion process. Sidewall exhausts and air intake vents are commonly discharged close to the ground, adjacent to the building and on the same side of the building. There are two basic systems for installing a two-pipe configuration (as opposed to a one-pipe configuration where air for combustion is taken from the room that the appliance is in). One is a side-by-side configuration, which uses adjacent conduits for the exhaust and air intake that terminate at two separate locations (see e.g., FIG. 1A which shows sidewall venting). The second is a concentric pipe configuration that has an exhaust pipe inside air intake pipe, both of which terminate at the same location (see e.g., FIG. 1B which shows sidewall venting). Concentric pipe configurations commonly comprise an anti-mixing baffle to isolate the air intake opening from the exhaust vent opening. These two basic venting configurations can be used to vent condensing appliances vertically, for example through an existing chimney chase, or horizontally, for example through a sidewall.

On cold days in cooler climates, the moisture plume from the exhaust vent of condensing appliances is clearly visible. If sidewall venting is used, warm moist exhaust gas moves up the wall of the building to any overhangs above, and/or is ejected into the space between adjacent buildings. As it encounters the cooler surfaces of a building it can condense and cause ice buildup. In areas where there is little distance between adjacent buildings, the exhaust gas from one building can cause ice buildup on the adjacent building. It is a common practice to install a redirection fitting on the vent termination to minimize the amount of moisture impacting the buildings opposite the vent termination. This practice increases the ice condensing surface area of the vent termination and additional icing takes place as a result of this practice. If two or more buildings vent exhaust gas into the same space, the air in that space can become very moist, exacerbating the buildup of ice. Ice buildup can also occur in and around the exhaust vent itself, impeding venting of the exhaust gas—not only will the appliance no longer function, it becomes a safety concern.

Also, water vapour in the fresh air that is drawn into the air intake conduit can condense on the air intake. This occurs primarily because the warm moist exhaust gas from the exhaust vent encounters the cooler surface of the air intake, causing the water vapour to form ice crystals in the air intake by de-sublimation, or by condensation followed by freezing. If condensing appliances from two or more buildings vent exhaust gas into the same space, the moisture of the air in that space is increased, exacerbating the buildup of frost in the air intake. If severe enough, the buildup of frost can impede the flow of air into the air intake to the extent that the appliance will no longer function. Frost buildup on air intakes is generally a problem in colder climates when the relative humidity is greater than about 25% and the outside air temperature is between about −4° C. and about −40° C. It is under these conditions that the water vapour is very close to its dew point and it condenses when it is drawn into the opening of air intake.

Attempts to avoid the buildup of ice frost on the air intake include applying electric heat tape to the pipes. However, this tape generally has insufficient capacity to avoid the problem, it requires an external power source, it can create further obstructions within the pipes themselves and it does not work well in extremely cold ambient conditions.

US 2002/0123305 by Tocher describes a fresh air intake that is allegedly designed to avoid plugging up during the winter with frost and snow. The intake comprises galvanized metal with a metal screen that has ¼″ open squares.

US 6,102,030 to Brown et al. describes a concentric furnace exhaust and intake configuration allegedly designed to avoid mixing of exhaust gas with intake air. In this device, the exhaust vent is configured as a nozzle to accelerate the exhaust gas away from the intake pipe and it is also disposed asymmetrically to further discourage the mixing of combustion air and exhaust gas.

US 2009/0017746 by Clemenz et al. describes an apparatus used for preventing the accumulation of snow, ice, frost and hail into or out of a building. The apparatus has a screen that is electrically connected to a heating device. The apparatus may be incorporated into new pipes or attached onto existing pipes.

U.S. Pat. No. 8,327,836 to Brown et al. describes a combined air intake and exhaust vent assembly that is attached to a pair of pipes extending outward from the side of a building. In this assembly the vent and intake terminals are separated and placed in side-by-side relationship.

A means of reducing or eliminating the deposition of frost on air intakes of condensing appliances is needed, as this remains a problem that is responsible for a large number of condensing appliance malfunctions, particularly in colder climates. There is further the need for a means of reducing or eliminating ice buildup at the exhaust vent terminus itself, which is also a problem for a large number of condensing appliances, particularly in colder climates. These problems are exacerbated in environments where multiple vents exhaust into a common shared space from which the combustion air is also drawn. It is particularly a problem in areas where buildings are close together. It would be desirable if the solution to these problems did not require the use of an external power source, but rather could be self-sustaining, and not require interlocking of the device to the appliance control system.

### SUMMARY

Described herein is an apparatus and method that prevents the laminar flow deposition of frost or ice at the air intake leading to a condensing appliance.

In one aspect provided herein is an apparatus comprising:

a) an exhaust gas passageway that transports a stream of exhaust gas away from a condenser of a condensing appliance to the outside atmosphere of a building;
b) an air intake opening that transports of a stream of combustion air from the outside atmosphere of the building towards the condensing appliance;
c) a heat-conducting path extending between the exhaust gas and frost condensing surfaces at or near the air intake opening, and said heat-conducting path having a first section for thermal contact with the exhaust gas and a second section for thermal contact with the frost condensing surfaces; and
d) said heat-conducting path being configured to be capable of the passive transfer of heat energy from the exhaust gas to the frost condensing surfaces.

In one embodiment the heat-conducting path is a heat pipe. In one embodiment the first section is an evaporator section of the heat pipe and the second section is a condenser section of the heat pipe. In one embodiment the heat pipe further comprises a heat sink thermally connected to the evaporator section. In one embodiment the heat pipe further comprises a heat dissipater thermally connected to the condenser section.

In another embodiment the heat-conducting path is a heat exchanger assembly. In one embodiment the first section is a flue gas exchanger and the second section is an air intake exchanger. The heat exchanger assembly may further comprise a heat pipe disposed in the flue gas exchanger.

In one embodiment the heat-conducting path is capable of the passive transfer of heat energy from the exhaust gas to the frost condensing surfaces when the temperature of the exhaust gas is between about 25° C. and 90° C. and the temperature of the combustion air is between about −40° C. and about −10° C. In one embodiment the heat-conducting path is capable of the passive transfer of heat energy from the exhaust gas to the frost condensing surfaces when temperature of the combustion air is between about −30° C. and about −15° C.

In one embodiment the heat-conducting path further extends between the exhaust gas and the terminus of the exhaust vent, said heat-conducting path being further configured to be capable of the passive transfer of heat energy from the exhaust gas to the ice-condensing surfaces at the terminus of the exhaust vent.

In one embodiment the heat-conducting path is further configured to be capable of the passive transfer of heat energy from the exhaust gas to the ice-condensing surfaces of a redirection fitting connected to the terminus of the exhaust vent. The heat conducting path may comprise one or more heat pipes.

In another aspect described is a method of avoiding frost buildup on frost condensing surfaces at or near an air intake opening of a condensing appliance, the condensing appliance having an exhaust vent that transports a stream of exhaust gas from the condensing appliance to the outside atmosphere of the building and an air intake pipe that transports a stream of combustion air from the outside atmosphere of the building through the air intake opening to the condensing appliance, the method comprising:

a) disposing a heat-conducting path between the exhaust gas and the frost condensing surfaces, said heat-conducting path having a first section in thermal contact with the exhaust gas and a second section in thermal contact with the condensing surfaces; and
b) transferring heat energy from the exhaust gas to the frost condensing surfaces along the heat-conducting path such that the condensing surfaces are heated by the heat energy, thereby avoiding frost buildup at or near the air intake opening.

In one embodiment of the method the heat-conducting path is a heat pipe. In one embodiment of the method the first section is an evaporator section of the heat pipe and the second section is a condenser section of the heat pipe. In one embodiment the heat pipe further comprises a heat sink thermally connected to the evaporator section. In yet another embodiment the heat pipe further comprises a heat dissipater thermally connected to the condenser section.

In another embodiment of the method the heat-conducting path is a heat exchanger assembly. In one embodiment of the method the first section is a flue gas exchanger and the second section is an air intake exchanger. The heat exchanger assembly may further comprise a heat pipe disposed in the flue gas exchanger.

In one embodiment of the method the heat-conducting path further extends between the exhaust gas and the terminus of the exhaust vent, said heat-conducting path being further configured to be capable of the passive transfer of heat energy from the exhaust gas to the ice-condensing surfaces at the terminus of the exhaust vent. In one embodiment the heat-conducting path is further configured to be capable of the passive transfer of heat energy from the exhaust gas to the ice-condensing surfaces of a redirection fitting connected to the terminus of the exhaust vent. The heat-conducting path may comprise one or more heat pipes.

In one embodiment of the method the relative humidity of the combustion air is greater than about 25%. In one embodiment the heat-conducting path transfers heat energy from the exhaust gas to the frost condensing surfaces when the temperature of the exhaust gas is between about 25° C. and 90° C. and the temperature of the combustion air is between about −40° C. and about −10° C. In one embodiment the heat-conducting path transfers heat energy from the exhaust gas to the frost condensing surfaces when the temperature of the combustion air is between about −30° C. and about −15° C.

In another aspect, described herein is an apparatus for avoiding frost buildup on the frost condensing surfaces at or near the opening of a combustion air passageway of a condensing appliance, said apparatus comprising:

a) an exhaust gas passageway that transports a stream of exhaust gas away from the exhaust vent of the condensing appliance to the outside atmosphere of a building,
b) an air intake opening for the combustion air passageway, said opening transporting a stream of combustion air from the outside atmosphere of the building towards the condensing appliance;
c) a heat-conducting path extending between the exhaust gas passageway and the air intake opening, the heat-conducting path having a first section in thermal contact with the exhaust gas in the exhaust gas passageway and a second section in thermal contact with the frost condensing surfaces; and
d) a baffle directing combustion air through the air intake opening, across the second section of the heat-conducting path and into the combustion air passageway.

In one embodiment the heat-conducting path is a heat pipe. In one embodiment the first section is an evaporator section of the heat pipe and the second section is a condenser section of the heat pipe. In one embodiment the heat pipe further comprises a heat sink thermally connected to the evaporator section. In one embodiment the heat pipe further comprises a heat dissipater thermally connected to the condenser section.

In another embodiment the heat-conducting path is a heat exchanger assembly. In one embodiment the first section is a flue gas exchanger and the second section is an air intake exchanger. The heat exchanger assembly may further comprise a heat pipe disposed in the flue gas exchanger.

In one embodiment the heat-conducting path further extends between the exhaust gas and the terminus of the exhaust vent, said heat-conducting path being further configured to be capable of the passive transfer of heat energy from the exhaust gas to the ice-condensing surfaces at the terminus of the exhaust vent.

In one embodiment the heat-conducting path is further configured to be capable of the passive transfer of heat energy from the exhaust gas to a redirection fitting connected to the ice-condensing surfaces at the terminus of the exhaust vent. The heat conducting path may comprise one or more heat pipes.

### BRIEF DESCRIPTION OF THE DRAWINGS

FIGS. 1A and 1B are side views of two different venting configurations known in the prior art and used for venting condensing appliances to the outside atmosphere of a building.

FIGS. 2A and 2B are schematic drawings of embodiments of the apparatus described herein.

FIG. 3 is an exploded view of an embodiment of the apparatus for assembly onto a concentric venting configuration.

FIG. 4A is a cross section through section A-A of the assembled embodiment of FIG. 3.

FIG. 4B is a cross section through section B-B of the assembled embodiment of FIG. 3.

FIG. 5 is an exploded view of an embodiment of the apparatus for assembly onto a concentric venting configuration.

FIG. 6A is a cross section through section A-A of the assembled embodiment of FIG. 5. FIG. 6B is a cross section through section B-B of the assembled embodiment of FIG. 5.

FIG. 7 is an exploded view of an embodiment of the apparatus for assembly onto a concentric venting configuration.

FIG. 8A is a cross section through section A-A of the assembled embodiment of FIG. 7. FIG. 8B is a cross section through section B-B of the assembled embodiment of FIG. 7.

FIG. 9 is an exploded view of an embodiment of the apparatus for assembly onto a concentric venting configuration.

FIG. 10A is a cross section through section A-A of the assembled embodiment of FIG. 9. FIG. 10B is a cross section through section B-B of the assembled embodiment of FIG. 9.

FIG. 11 is an exploded view of an embodiment of the apparatus for assembly onto a concentric venting configuration.

FIG. 12A is a cross section through section A-A of the assembled embodiment of FIG. 11. FIG. 12B is a cross section through section B-B of the assembled embodiment of FIG. 11.

FIG. 13 is an exploded view of an embodiment of the apparatus for assembly onto a concentric venting configuration.

FIG. 14A is a cross section through section A-A of the assembled embodiment of FIG. 13. FIG. 14B is a cross section through section B-B of the assembled embodiment of FIG. 13.

FIG. 15 is an exploded view of an embodiment of the apparatus for assembly onto a concentric venting configuration.

FIG. 16A is a cross section through section A-A of the assembled embodiment of FIG. 15. FIG. 16B is a cross section through section B-B of the assembled embodiment of FIG. 15.

FIG. 17 is an exploded view of an embodiment of the apparatus for assembly onto a concentric venting configuration.

FIG. 18A is a cross section through section A-A of the assembled embodiment of FIG. 17. FIG. 18B is a cross section through section B-B of the assembled embodiment of FIG. 17.

FIG. 19A is an exploded view of an embodiment of the apparatus for assembly onto a concentric venting configuration. FIG. 19B is a larger view of a heat-conducting path of this embodiment.

FIG. 20A is a cross section through section A-A of the assembled embodiment of FIG. 19A. FIG. 20B is a cross section through section B-B of the assembled embodiment of FIG. 19A. FIG. 20C is the same as FIG. 20B, with the addition of a heat pipe disposed in the heat-conducting path.

FIG. 21 is an exploded view of an embodiment of the apparatus for assembly onto a concentric venting configuration and used to avoid frost build-up on condensing surfaces and ice build-up on the exhaust vent terminus and/or redirection fitting.

FIG. 22 is a cross section through the assembled embodiment of FIG. 21.

FIG. 23A is a perspective view of an embodiment of the heat-conducting path that may be used in the apparatus shown in FIGS. 21 and 22A, B. FIG. 23B is an end view, and FIG. 23C is a side view.

FIG. 24A is an exploded view (right side) and assembled view (left side) of an embodiment of the apparatus for assembly onto adjacent conduits for the exhaust and air intake (a side-by-side configuration).

FIG. 24B is a cross section through the assembled embodiment of FIG. 24A.

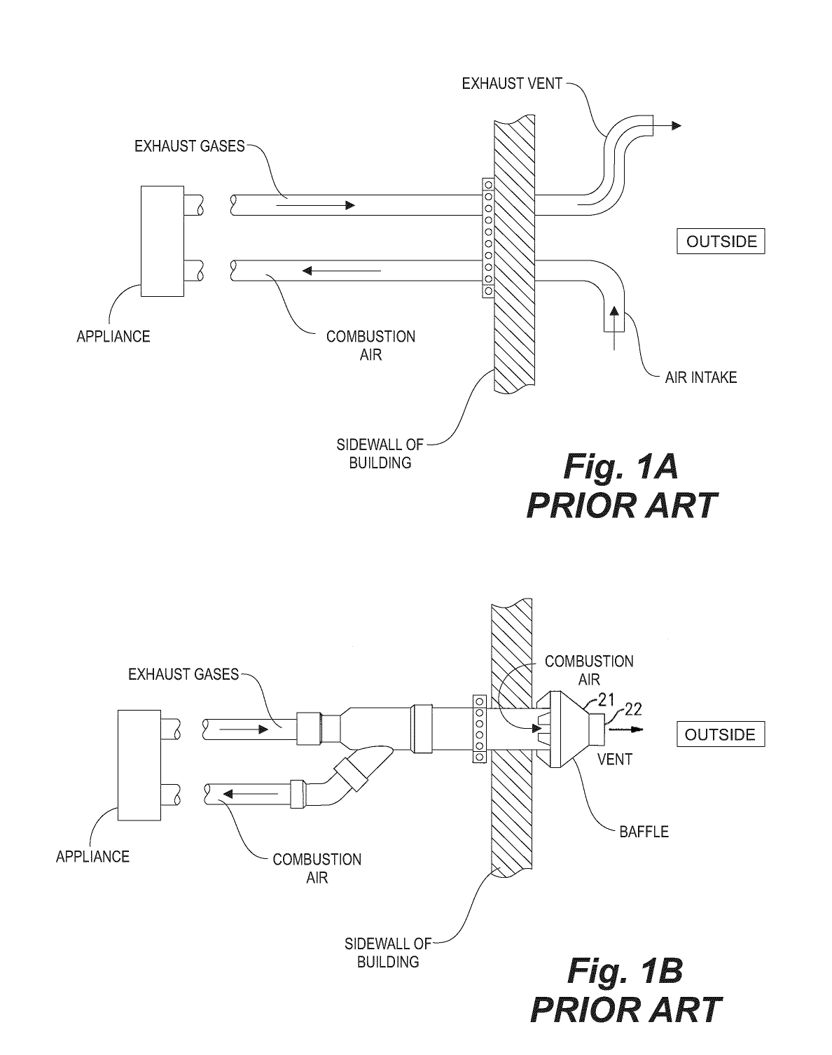

### DETAILED DESCRIPTION

Described herein is an apparatus and method that prevents the laminar flow deposition of frost or ice on the air intake leading to a condensing appliance or group of condensing appliances. The apparatus and method may be used in residential and light commercial buildings, and may be incorporated into new combustion air intakes being installed in a building, or installed onto an existing combustion air intake of a building. The apparatus may further be adapted to function to prevent deposition of ice in and on the exhaust vent terminus or redirection fitting leading from a condensing appliance or a group of condensing appliances.

The apparatus and method use a heat-conducting path to transfer heat from the exhaust gas exiting the exhaust vent of a condensing appliance to the condensing surfaces at or near the combustion air intake of the appliance, and in a further embodiment to the exhaust vent and/or termination fitting of the exhaust vent.

The “frost condensing surfaces” of the air intake opening are the surfaces of the air intake pipe onto which frost will deposit at colder temperatures. These surfaces are generally located at, or near, the combustion air intake opening or inlet and may be on the outside or on the inside of the air intake opening. More particularly, the disclosure herein provides for a heat-conducting path that absorbs heat energy from the outbound stream of exhaust gas and transfers this heat energy directly or indirectly to the frost condensing surfaces near the combustion air intake of the appliance. “Direct” heat transfer to the frost condensing surfaces occurs by physical contact between the heat-conducting path and the frost condensing surfaces, and the transfer of heat by conduction to the frost condensing surfaces. Direct heat transfer also occurs by the transfer of radiant energy from the heat-conducting path to the frost condensing surfaces. “Indirect” heat transfer to the frost condensing surfaces occurs when the heat energy is transferred from the heat-conducting path to an intermediary, such as a combustion air stream or a structure that is in physical contact with the condensing surfaces, and then this heat energy is conveyed from the intermediary to the frost condensing surfaces by way of convection or conduction.

By transferring heat energy from the exhaust gas stream to the frost condensing surfaces of the combustion air inlet, the condensing surfaces are heated sufficiently to reduce or eliminate the deposition of frost or ice on and around the edges of the air intake. Also, the velocity of the exhaust gas as it exits the exhaust vent may be reduced, meaning that the exhaust plume height is reduced. Two factors may contribute to the reduction in the exit velocity of the exhaust gas: a) the absorption of heat from the exhaust gas results in thermal contraction which reduces velocity, and b) an increase in the diameter of the exhaust vent (which will be explained more fully below) may reduce the velocity. An advantage of a reduction in the height of the exhaust plume may be a reduction in deposition of ice along the sides of buildings or under overhangs on buildings.

The cooling of the exhaust gas may also accelerate the condensation of the water vapour from the gas as it exits the exhaust vent, causing the water vapour to be deposited on the ground more readily. Since the water vapour may condense more readily when this apparatus is used, it does not remain suspended and available to be drawn into the air intake that is generally located nearby. The use of an adjustable exhaust cone fitting helps to accelerate the dispersion and control the water condensing pattern, and is also advantageous for reducing the likelihood of cross contamination between the flue gases and the combustion air.

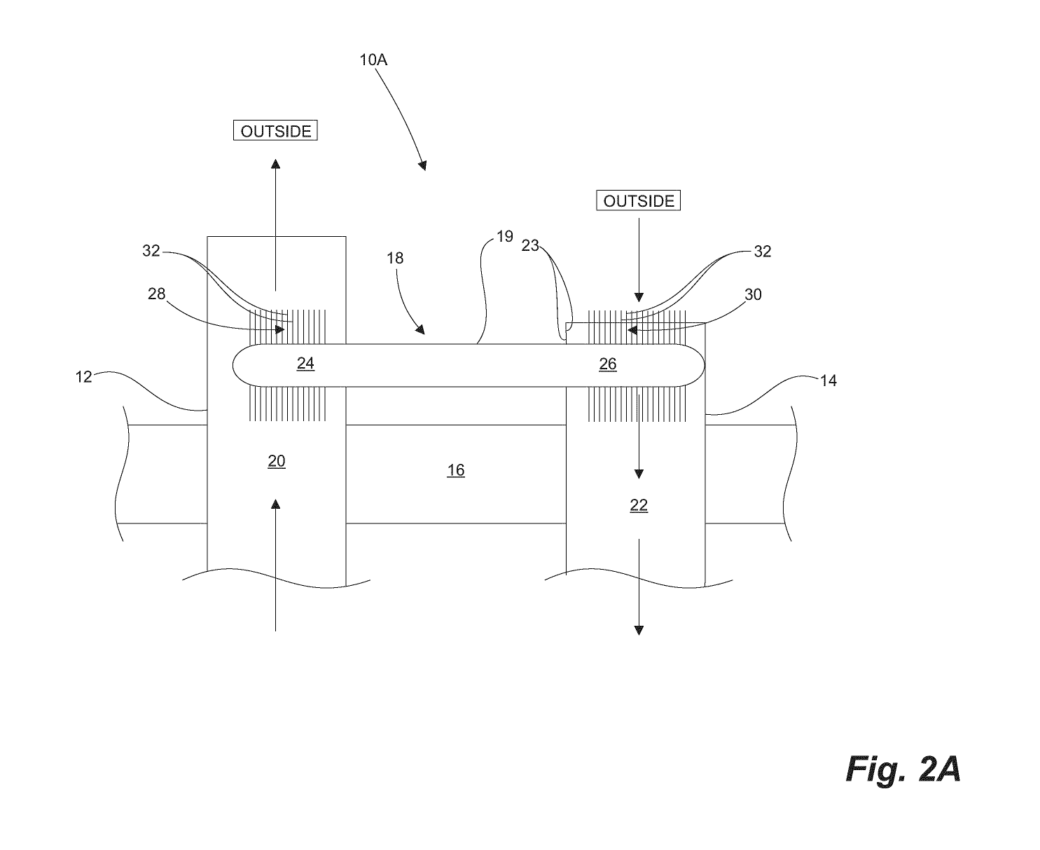

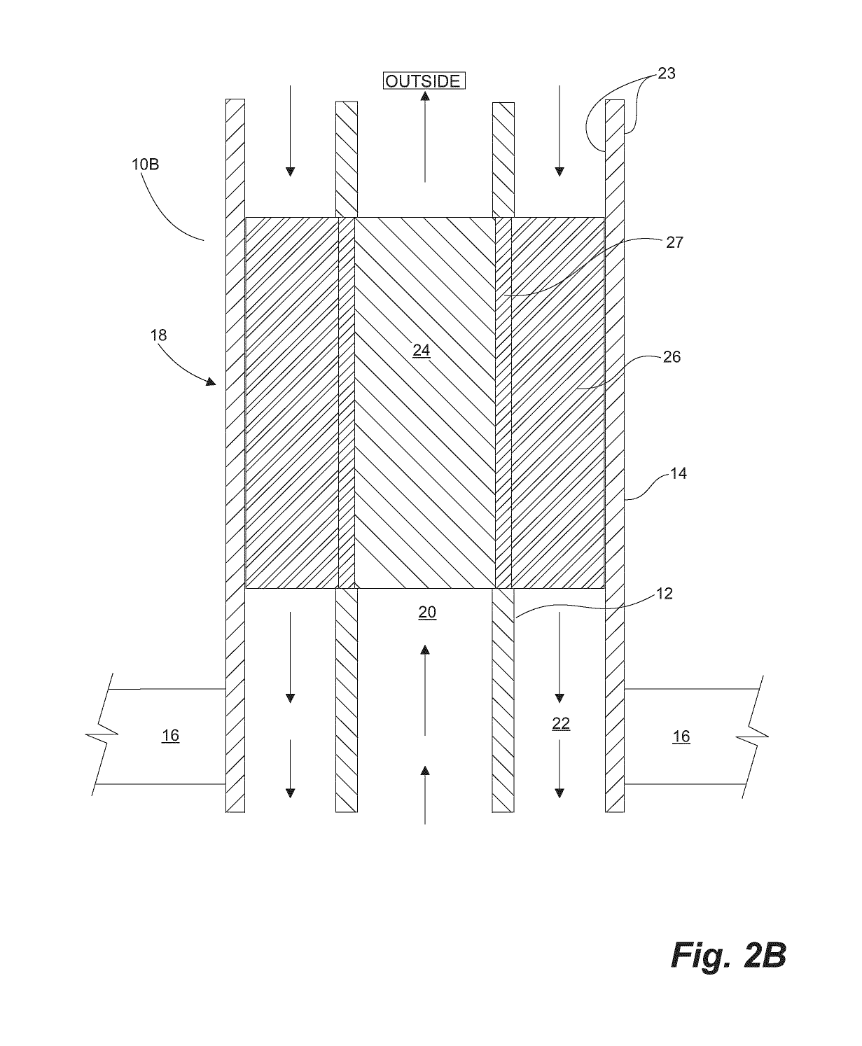

FIGS. 2A and 2B are schematic drawings of embodiments of the apparatus 10 disclosed herein. An exhaust vent or conduit 12 defining an exhaust gas passageway 20, and an air intake pipe or conduit 14 defining a combustion air passageway 22 are inserted horizontally through the wall 16 of a building or vertically through a roof of the building. The exhaust vent 12 defines the exhaust gas passageway that exhausts gas from the condenser of the condensing appliance to the outside atmosphere of the building, and may be the exhaust for one or a group of condensing appliances. “Exhaust gas” means the gaseous residual CO₂, water vapour, other compounds (e.g., CO) and particulates remaining after the combustion product of a condensing appliance has been condensed to remove at least some of its heat energy. This exhaust gas is distinct from the combustion product of the condensing appliance because it has about a 10 to 20% lower temperature. It is represented by arrows in exhaust vent 12, and exits the building. “Combustion air” is the air that enters the air intake from the outside atmosphere of the building and then flows along the combustion air passageway 22 to the combustion appliance (or group of combustion appliances), and is represented by arrows in air intake pipe 14. The mode of force for moving the exhaust gas and the combustion air is the combustion appliance fan.

The apparatus described herein provides a heat-conducting path 18 disposed between the stream of exhaust gas in the exhaust gas passageway and the frost condensing surfaces 23 at or near the opening of the combustion air passageway. The heat-conducting path 18 is activated by a temperature difference, and thus consumes no energy. Thus, the transfer of heat between the exhaust gas and the frost condensing surfaces 23 is passive. Further, because there are no moving parts, essentially no maintenance is required except for an occasional cleaning.

The heat-conducting path 18 comprises a first section 24 that is in thermal contact with the stream of exhaust gas that is flowing along or exiting the exhaust vent. First section 24 is positioned in thermal contact with the exhaust gas stream such that it is able to absorb enough heat-energy directly or indirectly from the exhaust gas to heat the frost condensing surfaces 23 at or near the air intake opening, and thereby avoid deposition of frost on these surfaces. The heat-conducting paths in FIGS. 2A and 2B are shown with the first section 24 disposed in the bore of the exhaust vent; this section may be at the terminus of the exhaust vent.

In the schematic shown in FIG. 2A, the heat-conducting path 18 may be a heat pipe and first section 24 is an evaporator section of the heat pipe. In the schematic shown in FIG. 2B the heat-conducting path 18 may be an exchanger assembly and the first section 24 is the flue gas exchanger component of this assembly.

The heat-conducting path 18 comprises a second section 26 that is in thermal contact with the frost condensing surfaces of the combustion air intake. Second section 24 is positioned such that it is able to transmit enough heat-energy directly or indirectly to the frost condensing surfaces to avoid deposition of frost thereon. This transfer of heat energy from the second section 26 to the frost condensing surfaces may be accomplished by one or a combination of the following means:

(a) physical contact between the second section of the heat-conducting path and the condensing surfaces of the air intake opening;
(b) physical contact between the second section and other structures that can conduct heat to the condensing surfaces;
(c) heating of the combustion air entering the air intake opening by the second section, which in turn transfers heat to the condensing surfaces by way of convection, and
(d) radiation of heat from the surface of the second section to the condensing surfaces.

In the schematic shown in FIG. 2A, the second section 26 may be a condenser section of a heat pipe. In the schematic shown in FIG. 2B the second section 26 may be an air-intake exchanger component of the exchanger assembly. The heat-conducting paths are shown with the second section 26 disposed in the bore of the air intake pipe at the opening of the air intake pipe; this section may also be disposed partly or completely in front of this opening, that is, in the flowpath of the stream of combustion air that will be drawn into the air intake pipe. In the heat pipe embodiment, the first and second sections of the heat pipe may additionally comprise a heat sink 28 and heat dissipater 30, respectively.

As used herein, “thermal contact” or “thermally connected” means either a direct contact or connection (e.g., physical contact), or an indirect contact or connection via an intermediary element (e.g., air, or a physical structure that conducts heat).

In use, as exhaust gas flows past the first section 24 heat energy is absorbed by the heat-conducting path 18 and this heat energy is then transferred along heat-conducting path 18 to the second section 26 and consequently to the frost condensing surfaces 23 at or near the air intake opening. Exhaust gas is therefore cooled by depleting heat energy, and the frost condensing surfaces 23 are heated by the energy that is depleted from the exhaust gas.

The apparatus and method herein heat the frost condensing surfaces 23 at or near the opening of the air intake. When air passes through the opening of the air intake, a pressure drop to below atmospheric pressure occurs, which causes a drop in temperature. The air intake therefore has a lower temperature at or near it's opening than the temperature of the air immediately around this opening. If the combustion air is close to its dew point, this lower temperature of the air intake opening can be sufficient to cause the condensation/de-sublimation of water vapour, and therefore the deposition of frost, in or around the opening. The second section of the heat-conducting path is therefore positioned near the pressure drop zone where the temperature has lowered, to keep the temperature of these condensing surfaces above the dew point, thus reducing or preventing laminar film condensation and the deposition of frost on these surfaces.

Heat-conducting path 18 is preferably made at least in part of a material that can be subjected to several freeze-thaw cycles, and to the corrosive exhaust gas. The heat-conducting path 18 may be made of a metal, an alloy, a resin, a mineral, a heat-conducting polymer, or the like, that has high thermal conductivity, e.g., without limitation steel, copper and aluminum. In some embodiments the heat-conducting path may be coated with a material that provides protection from corrosion by the acidic exhaust gas, but that will not interfere substantially with heat energy transfer.

### Heat Pipe Embodiment

In one embodiment the heat-conducting path 18 is a heat pipe. Heat pipes are a type of heat-conducting path that is very efficient in transferring heat from one location to another. A heat pipe is a closed metal container 19, often a tube, which contains a transport fluid in a vacuum until it reaches a boiling point and then becomes pressurized. When heat is applied to the outside of one end of the heat pipe, the liquid transport fluid inside vapourizes into a vapour that moves through the tube to the other end of the heat pipe which is cooler, and where it condenses back into a liquid. Because the vapourization of a liquid requires energy (the latent heat of vapourization) and the condensation of a vapour releases this energy (the latent heat of combustion), a heat pipe essentially absorbs heat from the environment at the end where vapourization occurs, and releases heat to the environment at the end where condensation occurs.

The inside of a heat pipe can contain a capillary structure such as a wick, which functions to return the condensate to the evaporator end via capillary action, thus allowing the heat pipe to operate irrespective of its orientation in a gravity field. A thermosyphon may be described as a “gravity return heat pipe”. Unlike a conventional heat pipe, a wick is not needed in a thermosyphon because gravity moves the transport fluid back to the evaporator section.

The first or evaporator section 24 of the heat pipe 18 is a heat-absorbing section, the second or condenser section 26 is a heat-dissipating section, and the two are connected by an essentially adiabatic middle section. The interior of the heat pipe is sealed from the exterior environment, and contains a transport fluid under vacuum that is capable of vapourizing at the evaporator section and condensing at the condenser section under the conditions to which the heat pipe will be exposed. The interior of the heat pipe may also comprise a capillary structure, such as a wick. Alternatively, or in addition, the evaporator section of the heat pipe may be lower than the condenser section of the heat pipe when assembled and in use, so that condensed transport fluid flows from the condenser section to the evaporator section with the assistance of gravity.

The heat energy that is transferred to evaporator section 24 from heat sink 28 (if present) causes the transport fluid inside the heat pipe to vapourize, and the resultant vapor then flows along the middle essentially adiabatic section to the condenser section 26 where it condenses back into liquid form, releasing heat energy that is transferred to dissipater 30 (if present) and consequently to the condensing surfaces at the air intake pipe 14.

The container 19 of the heat pipe may be formed from a thermally-conductive material such as a metallic substance, e.g., without limitation, aluminum, copper, stainless steel, or alloys thereof. The container material is non-porous. Preferably the container material is copper, as it is flexible and can withstand some corrosion. In some embodiments the heat pipe may be coated with a material that provides protection from corrosion by the acidic exhaust gas, but that will not interfere substantially with heat energy transfer (for example baked phenolic coatings that can be obtained from Heresite Protective Coatings LLC).

The heat pipe is hollow and has a sealed interior space that contains a transport fluid that is chosen according to the temperatures at which the heat pipe must operate. The transport fluid will, within the heat pipe, change from liquid to vapour and back again over the operating temperature range of the heat pipe, in this case between about −40° C. and about −10° C. (about −40° F. to about +15° F.) preferably between about −30° C. and about −15° C. (about −22° F. to about +5° F.) at the air intake condensing surfaces and between about 25° C. and about 90° C. (about 80° F. to about 200° F.) at the exhaust. The transport fluid used herein is, therefore, a substance or combination of substances that can change phase from liquid to vapour when the temperature of the evaporator section of the pipe attains a predetermined temperature due to the heat energy transferred from the stream of exhaust gas, and that can change from vapour to liquid when the temperature of the condenser section of the pipe attains a predetermined temperature due to the heat energy lost from transfer to frost condensing surfaces at the combustion air intake. The transport fluid also has sufficient heat capacity to deliver the required heat energy to the condenser, and thereby prevent frost accumulation at the air intake. Other considerations for the transport fluid are its compatibility with the wick and wall materials, its thermal stability, wettability of the wick and wall materials, its latent heat, thermal conductivity, viscosity in liquid and vapour form, surface tension and freezing point. The transport fluid may be, for example without limitation, water, methanol, ethanol and ammonia. Preferably the transport fluid is water.

The purpose of the capillary structure or wick, if used, is to generate capillary pressure to transport the liquid transport fluid from the condenser section to the evaporator section. It also distributes the transport fluid around the evaporator section to any area where heat is likely to be received by the heat pipe. The thickness of the wick, its compatibility with the working fluid and wettability are other factors that should be considered in selecting the appropriate wick. The wick may be made of materials such as, without limitation, steel, aluminum, nickel or copper, ceramics and carbon fibres. In one embodiment the heat pipe is a Thermacore® copper-water, sintered powder wick heat pipe which has a sintered copper powder wick structure that operates even against gravity, and can withstand numerous freeze-thaw cycles.

In the environment in which the heat pipe is to be used, and if water is used as the transport fluid, a wick which can freeze and expand internally in the pipe without compromising the operational ability of the pipe is required. Further, the amount of transport fluid used is such that the evaporator and condenser sections are not waterlogged, and is only enough to keep the wick saturated, avoiding amounts that would result in detrimental freezing and consequent damage to the heat pipe.

The volume, shape and dimensions of the heat pipe used in the apparatus described herein can be varied, provided however that the heat pipe is able to deliver an amount of heat energy to the air intake condensing surfaces that is sufficient to prevent frost accumulation, and that it can withstand the thermal cycling and frosting/freezing environments in which it will be used. The configuration of the heat pipe will therefore depend on a number of factors including the size of the exhaust and air inlet conduits, the configuration of the conduits and their distances from one another, the BTUH size of the condensing appliance and the climate, to name a few. The device may have more than one heat pipe and therefore may have more than one evaporator section and more than one condenser section. It may be made of a flexible material if some range of motion is required. It may be a tubular or flat heat pipe, a variable conductance heat pipe, a diode heat pipe, a thermosyphon or a loop heat pipe. Preferably it is tubular.

Heat sink 28 and heat dissipater 30 are passive heat exchangers that absorb heat from the surrounding medium and that dissipate heat into the surrounding medium, and may be disposed at the first and second sections, respectively, of the heat pipe. Gases exiting from exhaust vent 12 will circulate over and around heat sink 28 and combustion air entering air intake pipe 14 will circulate over and around dissipater 30. Heat sink 28 and heat dissipater 30 are optimally designed to provide minimal resistance to airflow while at the same time maximizing the amount of heat energy being transferred to and from them. Because exhaust gas is corrosive, the materials for construction are preferably corrosion resistant. Heat sink 28 and heat dissipater 30 may be made of a metal, an alloy, a resin, a mineral, a heat-conducting polymer, or the like, that has high thermal conductivity, e.g., without limitation copper and aluminum. Preferred for use herein is aluminum and its alloys, and specifically 6063-T6 aluminum alloy.

Heat sink 28 comprises a structure having a surface for absorbing heat and a surface for thermal connection to the evaporator section 24 of heat pipe 18. Heat dissipater 30 comprises a structure having a surface for dissipating heat and a surface for thermal connection to the condenser section 26 of heat pipe 18.

To effectively absorb heat from the exhaust gas and dissipate heat to the frost condensing surfaces of the air intake, heat sink 28 and heat dissipater 30 respectively preferably have fins 32, to allow as much contact as possible with the gas or air passing over them. As seen in the embodiments shown in the Figs. herein, the heat sink and dissipater may have an elongated through channel for receiving the end of the heat pipe therethrough, to establish a thermal connection.

In operation, heat sink 28 will absorb heat energy from the exhaust gas passing along or exiting exhaust vent 12 and transfer this heat energy to heat pipe 18. Heat dissipater 30 will absorb heat energy from heat pipe 18 and dissipate this heat energy to the frost condensing surfaces 23 of the air intake.

In order to offset the cross-sectional area of the heat pipe, and maintain the required air flow capacity, in some embodiments the cross-sectional area of the bore of the exhaust vent may be increased from conventional sizes. Thus for example, if the diameter of a conventional exhaust vent pipe is 2 or 3 inches, and the diameter of the heat pipe is ½ inch, the diameter of the exhaust vent pipe may consequently be increased to 2.5 or 3.5 inches, respectively, to accommodate the heat pipe in its bore without a reduction in air flow. Consequently, in these embodiments, because the net area of the bore of the exhaust vent is greater at its exit opening, the velocity of the exhaust gas is reduced as compared to the narrower bore with a lower net area exit opening.

Having thus described the basic apparatus and method herein, specific embodiments of the heat-conducting path using a heat pipe will now be described and shown in the accompanying Figures. These embodiments are designed to be used on a new vertical or horizontal installation of exhaust vents and air intakes, or to retrofit a prior installation.

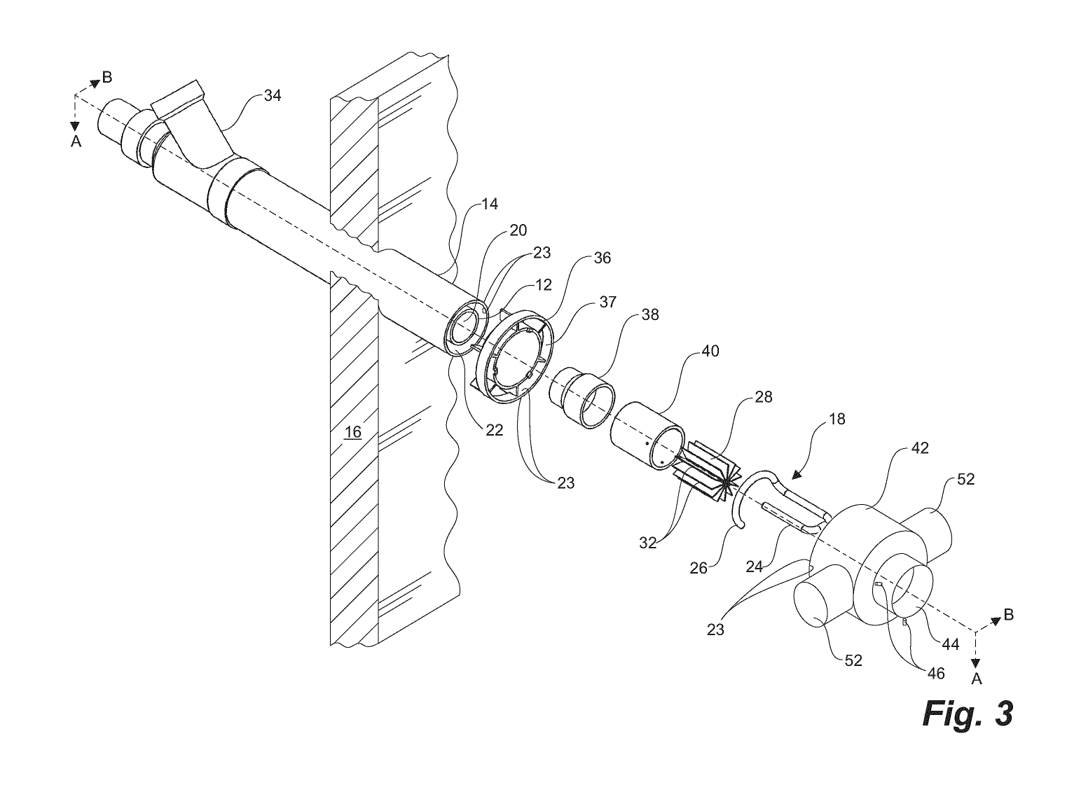

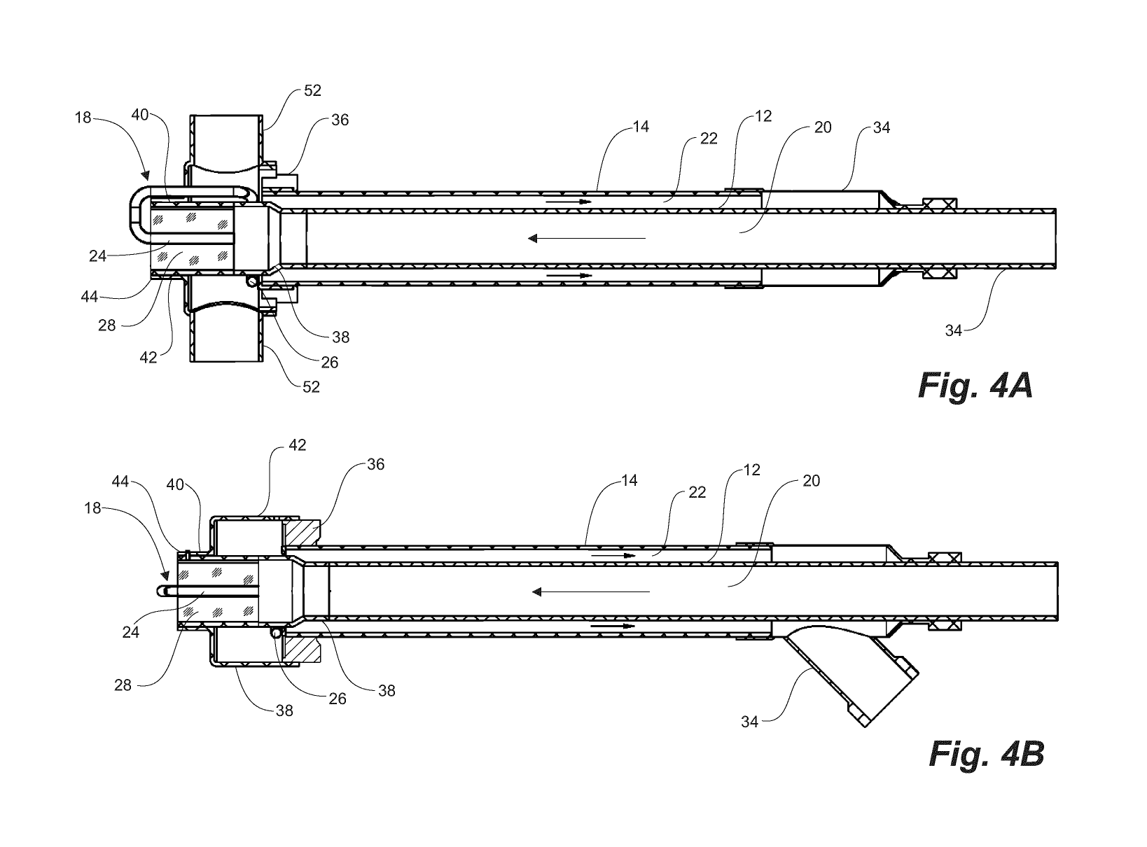

FIGS. 3, 4A and 4B show one embodiment of the apparatus described herein. FIG. 3 shows an exploded view of the apparatus disposed on a concentric two-pipe configuration that extends through the sidewall 16 of a building. The concentric configuration comprises a conventional exhaust vent or conduit 12 that defines an exhaust gas passageway 20, an air intake pipe or conduit 14 that defines a combustion air passageway 22 around the exhaust vent 12, and a 50° socket tee 34 to direct the stream of combustion air to the appliance. This type of concentric two-pipe configuration is known in the art and is used to vent exhaust gas and supply combustion air to appliances such as boilers, furnaces and hot water tanks.

The embodiment comprises an air intake bracket 36, a reducer coupling 38, an exhaust vent extender 40, a heat pipe 18, a heat sink 28 and a baffle 42. Air intake bracket 36 functions to centre and hold baffle 42 on the air intake pipe 14. Air intake bracket also has an opening 37 for communicating the incoming combustion air into the baffle 42 and subsequently to the opening of and into the air intake pipe 14. Thus, the air intake bracket and baffle extend the combustion air passageway 22 beyond the opening of the air intake pipe. Reducer coupling 38 functions to increase the diameter of the exhaust vent 12 to offset the diameter of heat pipe 18. In this embodiment, reducer coupling 38 may increase the diameter of the exhaust vent from 2.5 to 3.0 inches. Exhaust vent extender 40 extends between coupling 38 and the end 44 of baffle 42, and its bore houses heat pipe 18 and heat sink 28. Thus, the reducer coupling and exhaust vent extender extend the length of exhaust gas passageway 20.

In this embodiment the reducer coupling 38 is sealably engaged to the exhaust vent 12, and to the exhaust vent extender 40, so that exhaust gas does not contaminate the combustion air that is drawn into the air intake pipe 14 (except to the extent that this may happen after the exhaust gas exits the exhaust vent). This sealed engagement can be accomplished for example by gluing. Air intake bracket 36 is further sealably engaged to air intake pipe 14, for example by gluing the bracket around and to the outside of the air intake pipe.

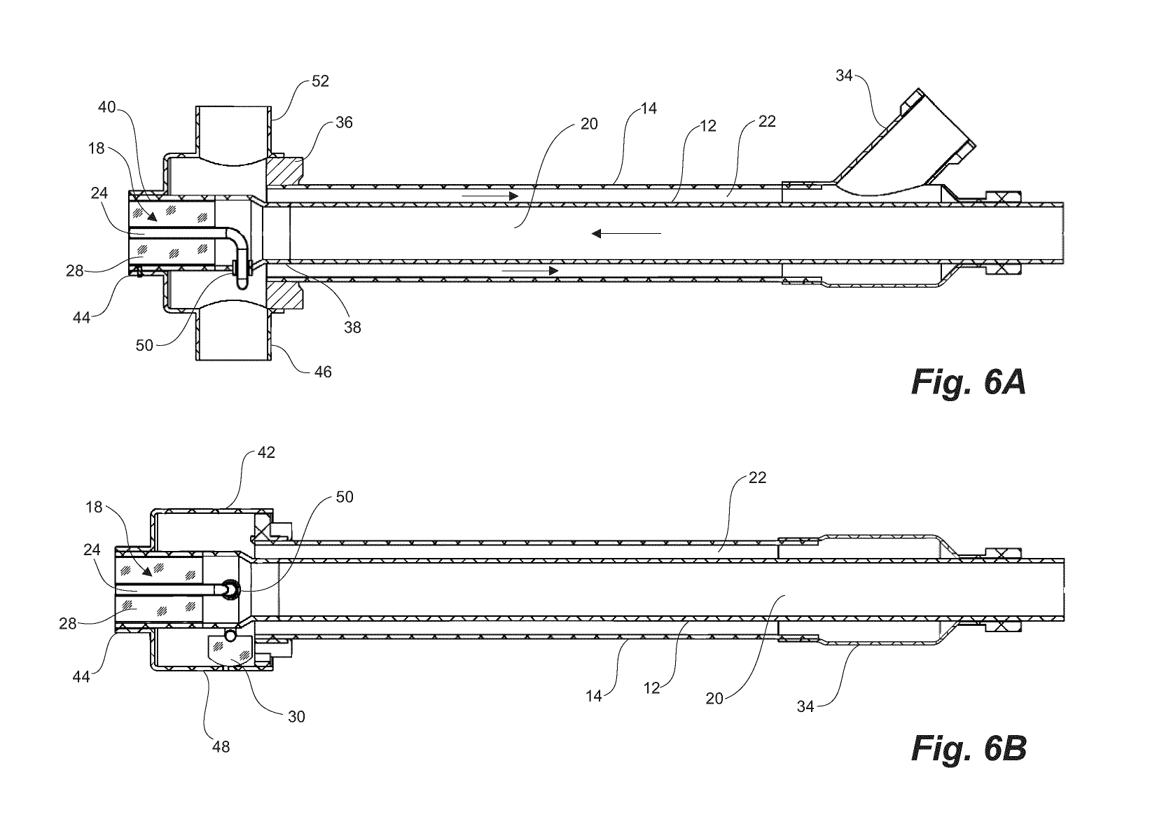

Baffle 42 surrounds the condenser section 26 of the heat pipe and functions to direct the path of incoming combustion air over the condenser section of the heat pipe and into the air intake pipe. Also, by protecting the condenser section 26 of the heat pipe from the outside atmosphere, baffle 42 prevents the loss of the heat to the environment due to convective heat transfer. Baffle 42 maintains its known function, which is to separate the exhaust gas from the combustion air being drawn into the air intake pipe 14. Preferably baffle 42 is removable so that the heat pipe can be serviced and/or replaced, if needed. To this end, set screws 46 are used to fasten the baffle 42 to the exhaust vent extender 40. Further, baffle 42 may comprise a weep hole 48 (FIG. 6B) to release any condensation products formed within the baffle.

FIGS. 4A and 4B show cross sectional views taken along line A-A and line B-B of FIG. 3. These figures show heat sink 28 extending across the diameter and along the bore of the exhaust vent extender 40, to the end 44 of baffle 42. An evaporator section 24 of heat pipe 18 extends through the middle of heat sink 28 and is thermally connected to it. Heat pipe 18 extends along the outside surface of exhaust vent extender 40, and then condenser section 26 wraps around the outside of reducer coupling 38, at the entrance to air intake pipe 14. In this embodiment, heat pipe extends about 225° around exhaust vent extender 14 and may physically contact the exhaust vent extender 14 and/or air intake bracket 36. The condensing surfaces 23 of this embodiment of the apparatus may include the inside and outside surfaces of the air intake pipe 14 near the opening of the pipe, and the inside and outside surfaces of the air intake bracket 36 and baffle 42.

As exhaust gas exits exhaust vent 12, it passes by heat sink 28, which absorbs heat energy from this gas. Heat sink 28 transfers this energy to evaporator section 24 of heat pipe 18, which causes vapourization of the transport fluid in the inside of the heat pipe. This vapour passes along heat pipe 18 to the condenser section 26, which extends around exhaust vent 12 at the entrance to air intake pipe 14. At condenser section 26 the vapour inside heat pipe 18 condenses and releases the heat energy. The heat energy may be transmitted directly to condensing surfaces 23 by contact between the condenser section and the air intake condensing surfaces. Combustion air passes through the openings 37 of air intake bracket 36, and across the condenser section 26 where it absorbs the heat energy and the air may transfer some of this heat energy to the condensing surfaces of the air intake. Because the air intake condensing surfaces are heated, the water vapour in the air surrounding the air intake, or in the combustion air, is less likely to condense and form frost on these surfaces.

A reduction in the exhaust gas exit velocity may be another advantage of some embodiments of the apparatus and method disclosed herein. This reduction in velocity may change the location, dispersion pattern and condensation pattern of the exhaust gas in the area adjacent to the exhaust outlet. This may be accomplished by expanding the diameter of the exhaust vent and/or by thermal contraction of the exhaust gas. Exhaust vent 12 may have a larger diameter than the opening of the concentric venting configuration that would exist were the instant apparatus not installed on it (in the case of this embodiment, 3 inches instead of 2.5 inches), which reduces the velocity of the exhaust gas as it exits the exhaust vent. Further, thermal contraction from cooling of the exhaust gas may lower exit velocity.

The cooling of the exhaust gas may also have the added benefit of promoting the condensation of the water vapour to earlier than is observed if the apparatus is not used—the water vapour drops more readily to the ground when it exits the exhaust vent. Thus, the amount of water vapour that would otherwise be introduced into the outside atmosphere surrounding the air intake is reduced, which may further reduce frost accumulation on this vent. And, the amount of water vapour that would otherwise be expelled into the outside atmosphere surrounding the exhaust vent, to be deposited on the walls and overhangs of buildings or on the exhaust vent itself may be reduced. This is an important advantage particularly where there are multiple appliance exhaust vents terminating into a common local venting area. In this type of environment frost accumulation on appliance vents can be severe, especially when a prevailing wind can concentrate water vapour at all combustion air intakes located in the area.

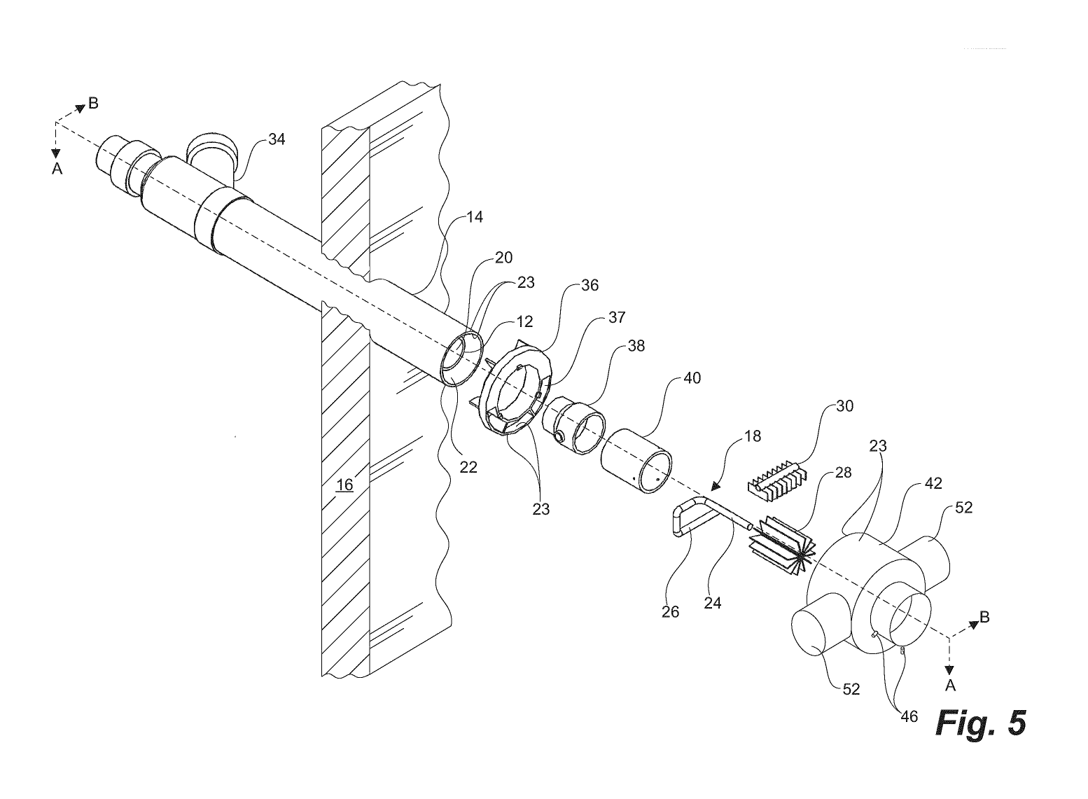

FIG. 5 shows and exploded view of another embodiment of the apparatus disposed on a concentric two-pipe configuration that extends through the wall 16 of a building. The concentric configuration is as described above for the embodiment shown in FIG. 3.

This embodiment likewise comprises an air intake bracket 36, a reducer coupling 38, an exhaust vent extender 40, a heat pipe 18, a heat sink 28 and a baffle 42. In addition, it comprises a heat dissipater 30 disposed on the heat pipe 18. Reducer coupling 38, exhaust vent extender 40, baffle 42 and heat sink 28 are as described for the embodiment in FIGS. 3, 4A and 4B.

Air intake bracket 36 functions to centre and hold baffle 42 on the air intake pipe 14. Air intake bracket 36 also has an opening 37 for communicating the combustion air into the opening of the air intake pipe 14. However, unlike the air intake bracket shown in FIG. 3 a portion of the collar of the air intake bracket is obstructed. This is done so that incoming combustion air is forced to travel over condenser section 26 and heat dissipater 30, before entering air intake pipe 14.

FIGS. 6A and 6B show cross sectional views taken along line A-A and line B-B of FIG. 5. These figures show heat sink 28 extending across the diameter and along the bore of the exhaust vent extender 40, to the end 44 of baffle 42. An evaporator section 24 of heat pipe 18 extends through the middle of heat sink 28, and then heat pipe 18 continues through the wall of exhaust vent extender 40, and into baffle 42. A half-coupling 50 secures the heat pipe as it passes through the exhaust vent extender wall. The condenser section 26 of heat pipe 18 extends around the wall of exhaust vent extender 40, but is spaced from it to allow heat dissipater 30 to be inserted over it. Heat dissipater 30, extends around a bottom portion of exhaust vent 12 at the opening of air intake pipe 14 at the pressure drop zone.

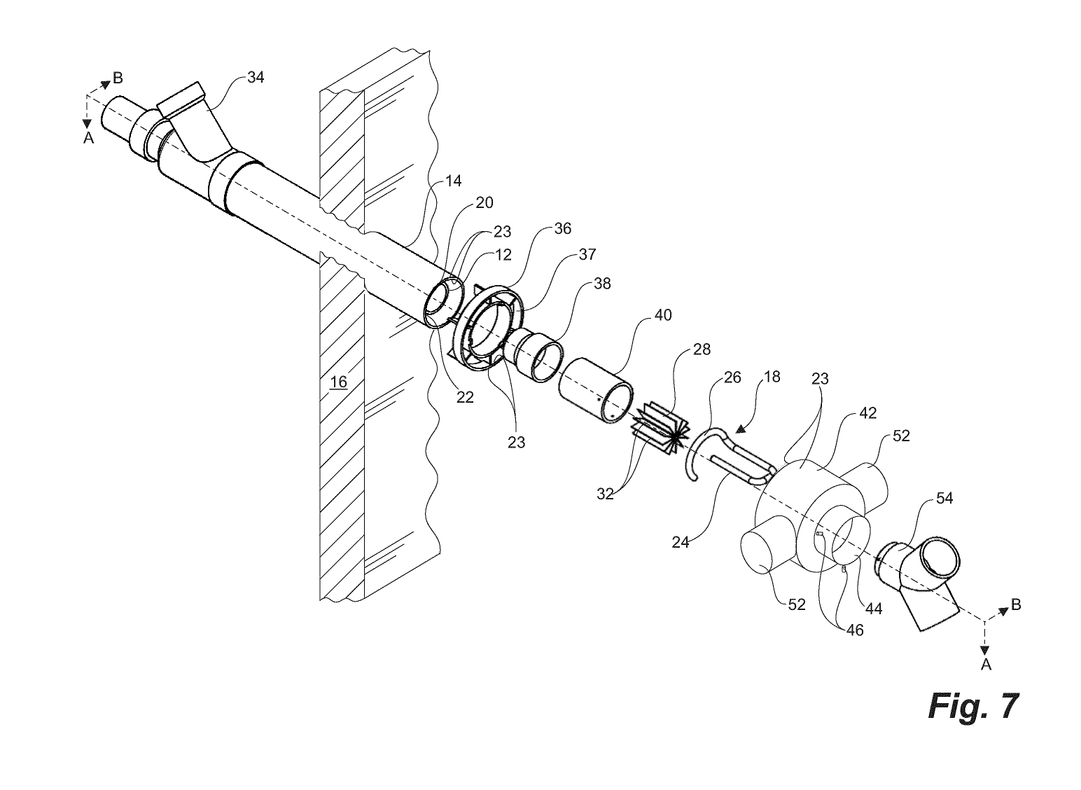

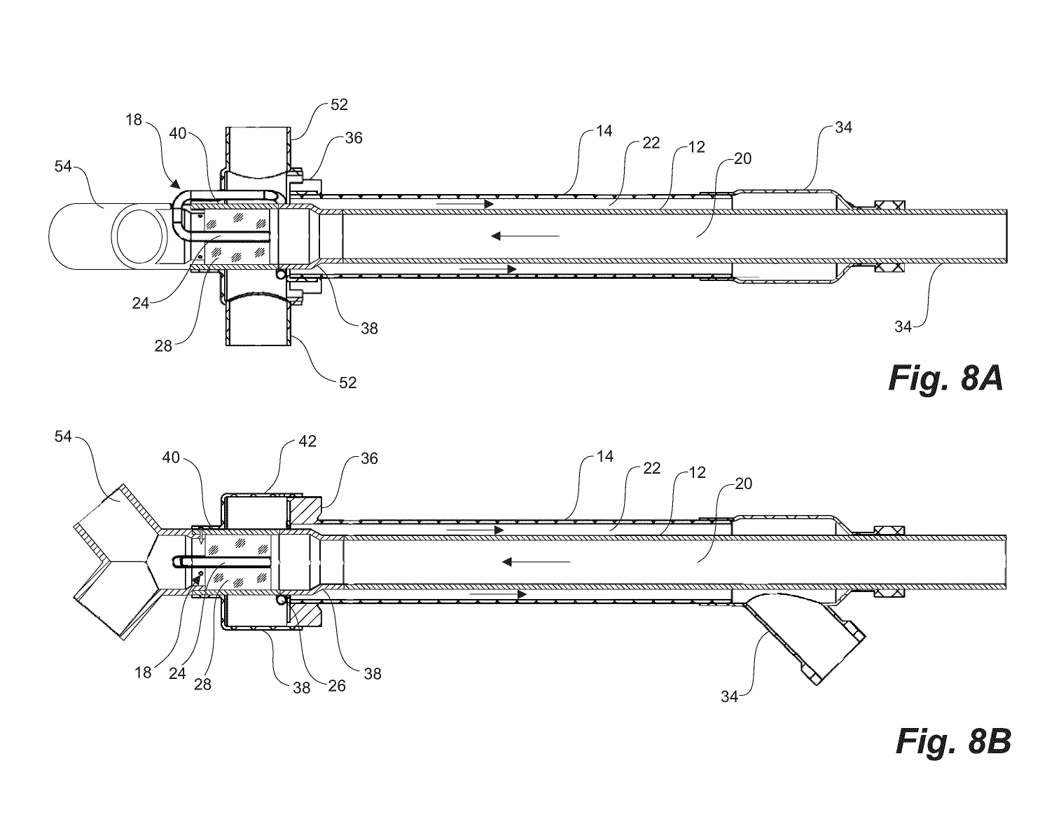

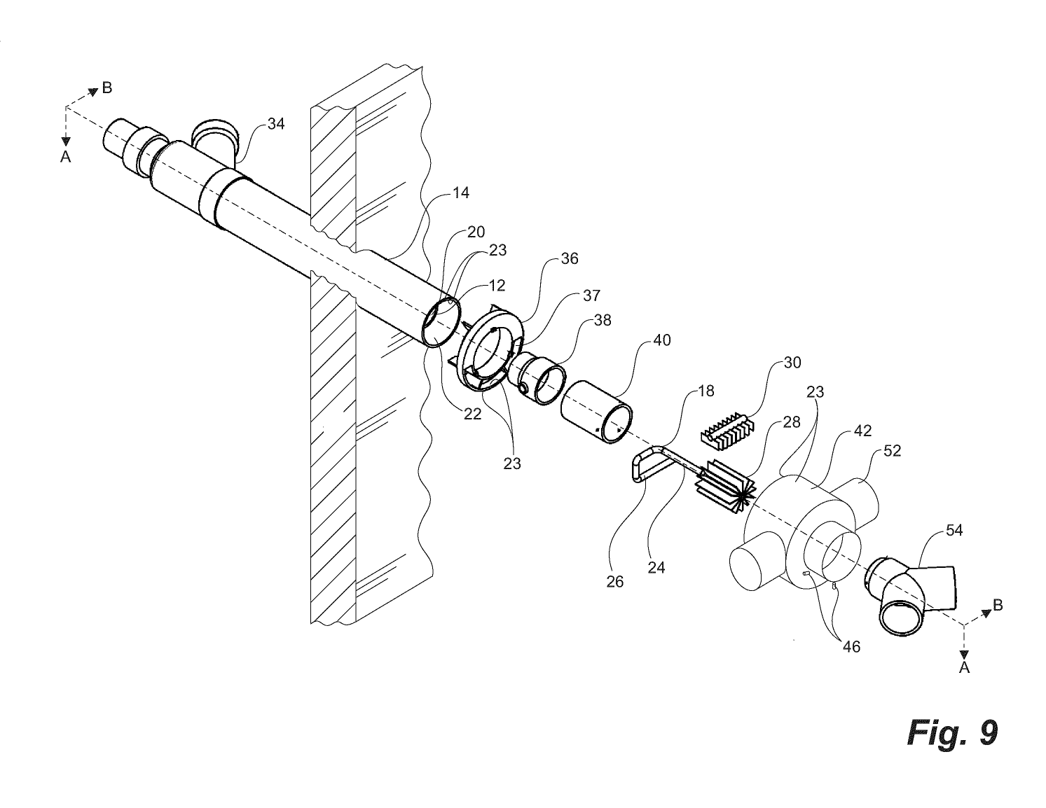

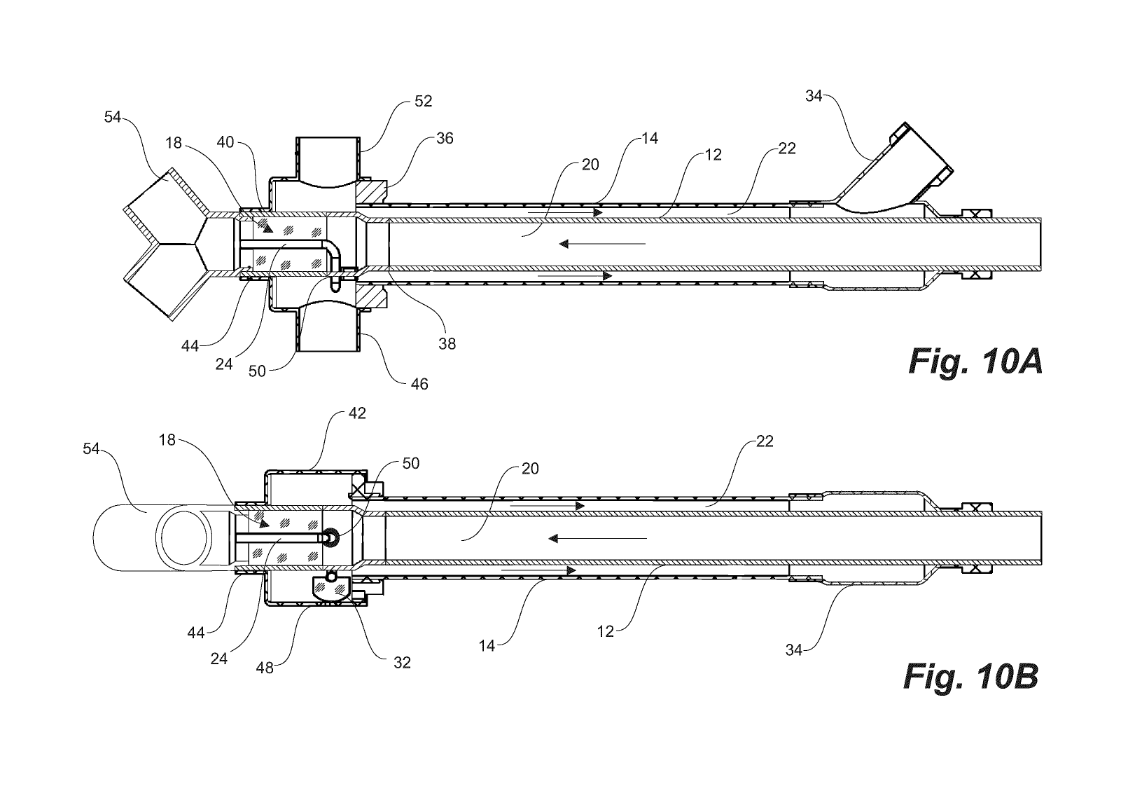

FIGS. 7 to 10B show alternative embodiments of the apparatus described herein which are similar to the embodiments shown in FIGS. 3 to 6B, except in that they have an additional exhaust Y termination fitting 54 (a redirection fitting) that is sealably connected to the end 44 of baffle 42. As can be seen, in the embodiments shown in FIGS. 8A and 8B, the heat pipe extends outwards through the wall of the Y-fitting and into the baffle.

Embodiments with the Y-termination fitting are preferred for use in horizontal sidewall installations. The Y-termination is superior to the T-termination (a redirection fitting), which is known in the art, because it reduces the cross-contamination of combustion air by the exhaust gas as compared to a T-termination. The Y-termination can provide an upward gas flow and a downward gas flow directed away from the building, with a condensation drip report on the bottom outlet, to accomplish the same desired effect as a T-termination without increasing the rate of recycling of the exhaust gas into the combustion air intake.

The apparatus described herein may be used to retrofit a concentric vent configuration in which the exhaust vent is inside the air intake pipe, or it may be used to retrofit a side-by-side configuration, which has adjacent exhaust gas and air intake conduits. To enable both types of installations, the embodiments shown in FIGS. 3 to 10B comprise two lateral ports 52 extending from baffle 42. When used on a concentric vent configuration, the two lateral ports 52 are capped and the stream of combustion air is drawn through opening 37 in air intake bracket 36, into the baffle 42, and across the evaporator section 24 of the heat pipe and/or heat dissipater 30, before entering the air intake pipe.

If the apparatus is used on a side-by-side installation one or both of the lateral ports 52 are used to fluidly connect the combustion air that is drawn into baffle 42 to the separate air intake pipe. The stream of combustion air therefore passes through opening 37 in air intake bracket 36, and across the evaporator section 24 of the heat pipe and/or heat dissipater 30, before it exits at port 52 to flow to the separate air intake pipe.

When used in a side-by-side installation air intake bracket 36 may also be modified to slide over and sealably connect to the separate exhaust vent 12. Thus, as compared to the bracket shown in the embodiments of FIGS. 3 to 6B, the inner ring of air intake bracket 36 may have a smaller circumference to fit around the exhaust vent. Alternatively, a reducer coupling or flush bushing may be used to connect the baffle 42 to the exhaust vent.

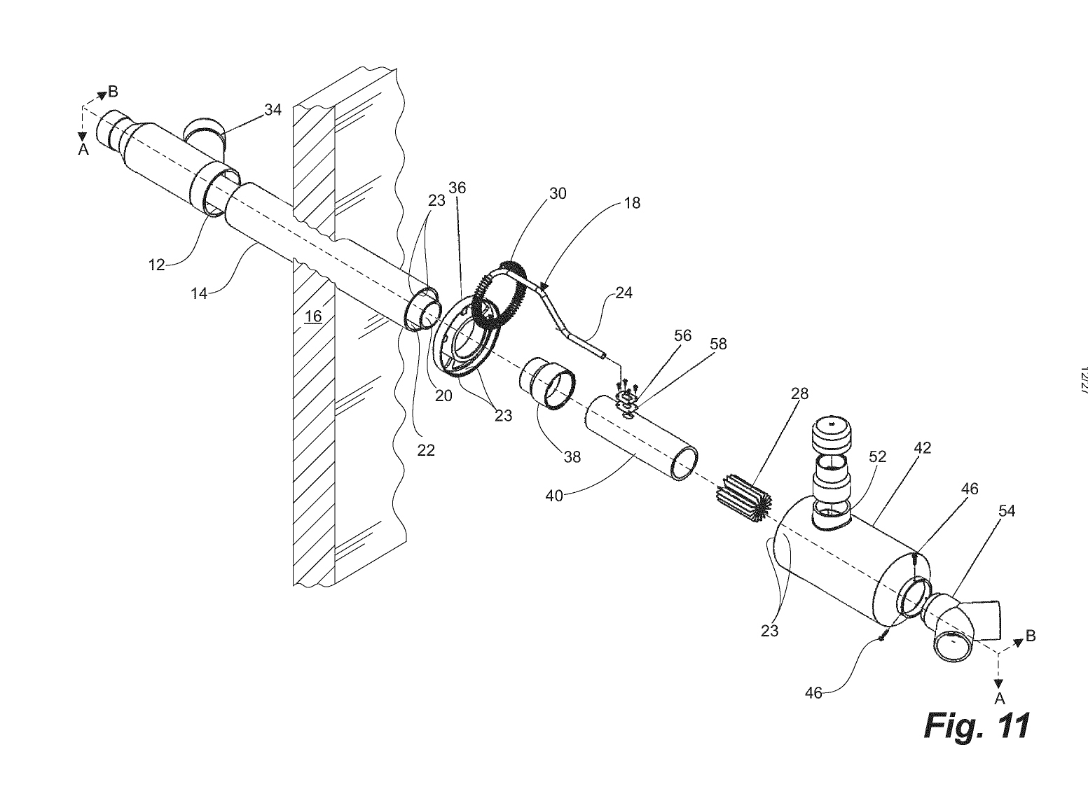

FIG. 11 shows an exploded view of another embodiment of the apparatus disposed on a concentric two-pipe configuration that extends through the wall 16 of a building. The concentric configuration is as described above for the embodiment shown in FIG. 3.

This embodiment comprises an air intake bracket 36, a reducer coupling 38, an exhaust vent extender 40, a heat pipe 18, a heat sink 28, a baffle 42 and a Y-termination 54. Heat pipe 18 is configured differently than the heat pipe of the embodiment shown in FIG. 3, and extends directly through the side of the exhaust vent extender rather than wrapping around it. The heat pipe is sealably connected to the exhaust vent extender by a flange 56 and flange gasket 58.

Unlike the embodiment of FIG. 3 and like that of FIG. 5, the heat pipe comprises a heat dissipater 30 on the condenser section. The condenser section 26 and heat dissipater 30 extend essentially around the entire circumference of the air intake pipe 14. Thus, as compared to the embodiment shown in FIG. 3, the condenser section of the heat pipe is disposed around the outside of air intake pipe 14 in the opening 37 of the air intake bracket 36, rather than directly in front of the opening of the air intake pipe 14.

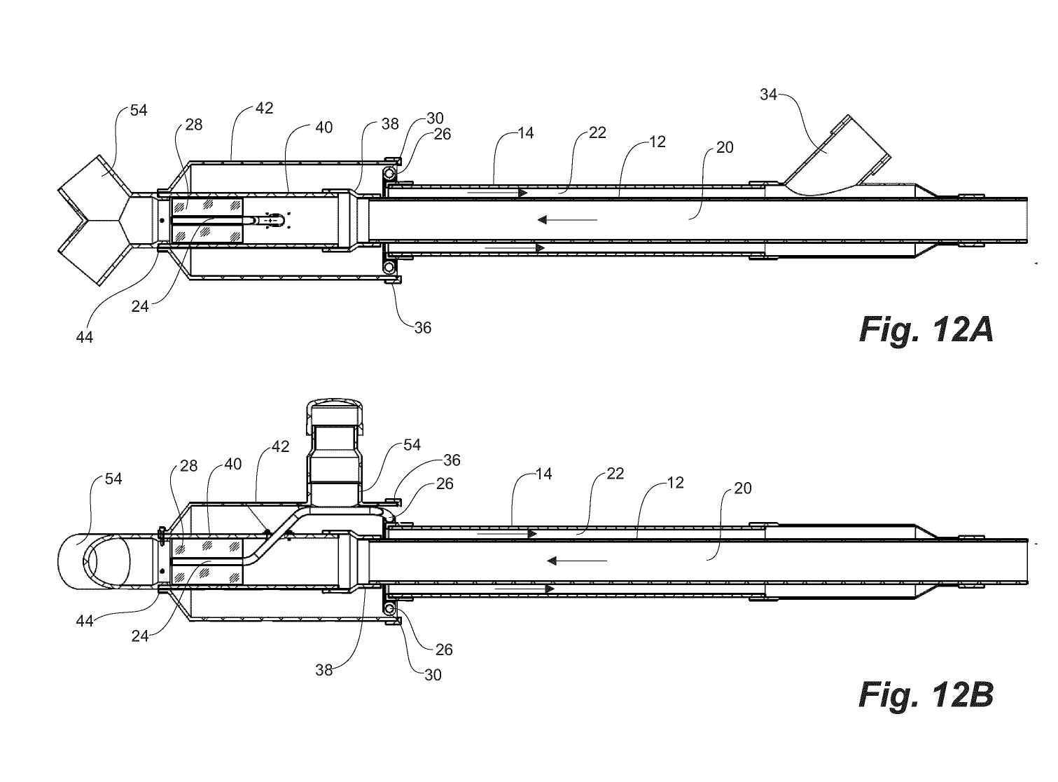

FIGS. 12A and 12B show cross sectional views taken along line A-A and line B-B of FIG. 11. These figures show heat sink 28 extending across the diameter and along the bore of the exhaust vent extender 40, to the end 44 of baffle 42. An evaporator section 24 of heat pipe 18 extends through the middle of heat sink 28, and then heat pipe 18 continues through the wall of exhaust vent extender 40, into baffle 42. The condenser section 26 and heat dissipater 30 extend around the air intake pipe 14 inside the opening of the bracket.

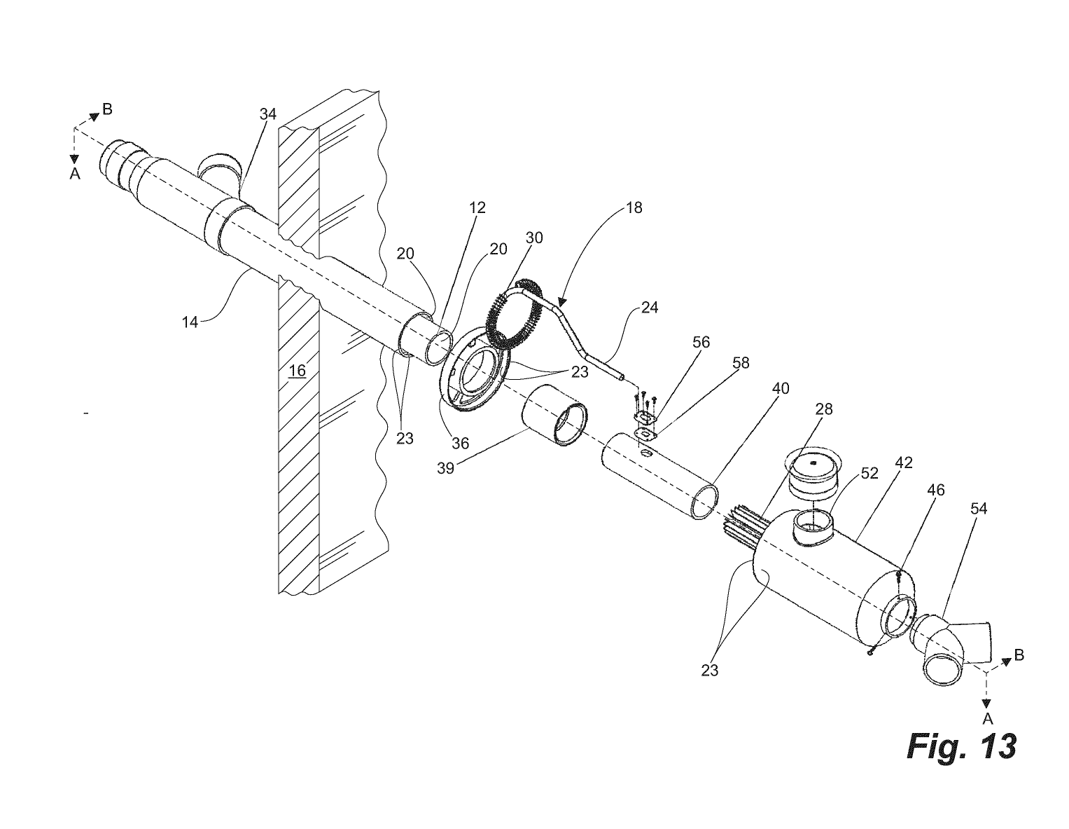

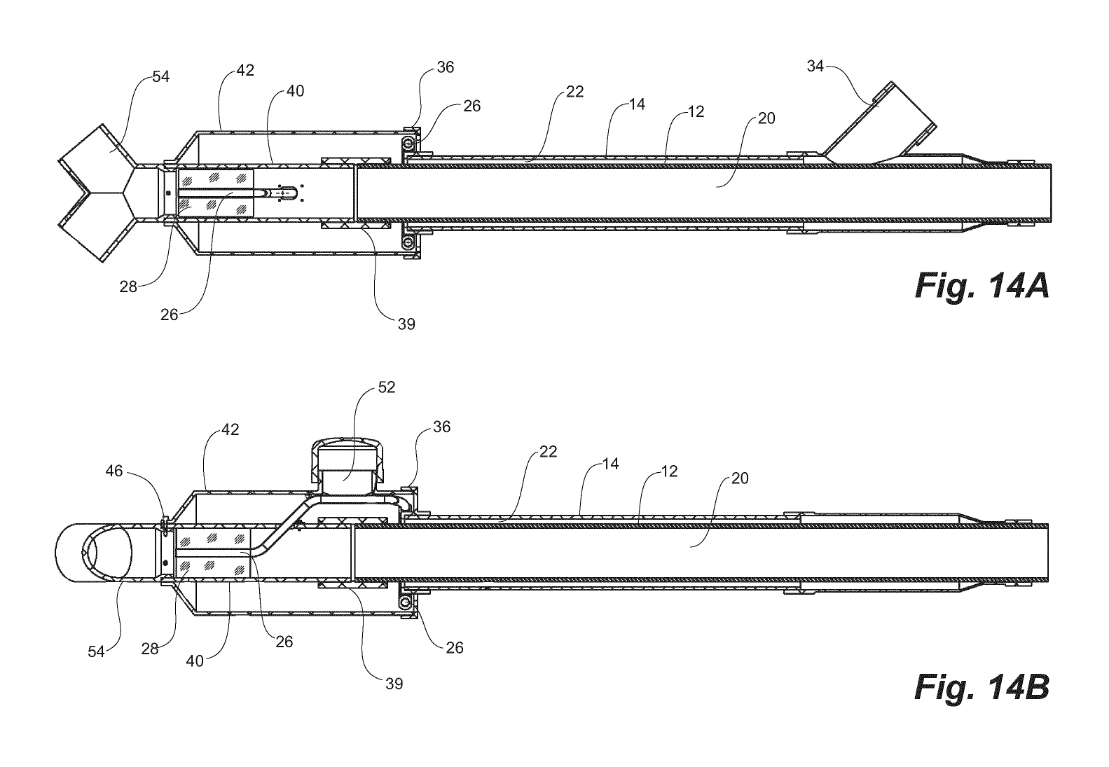

The embodiment shown in FIGS. 13, 14A and 14B is similar to that of FIGS. 11, 12A and 12B except in that the coupling 39 used to couple the exhaust pipe 12 to the exhaust pipe extender 40 is not a reducer coupling. Therefore, in this embodiment there is no increase in cross-sectional area of the exhaust pipe to offset the diameter of the heat pipe.

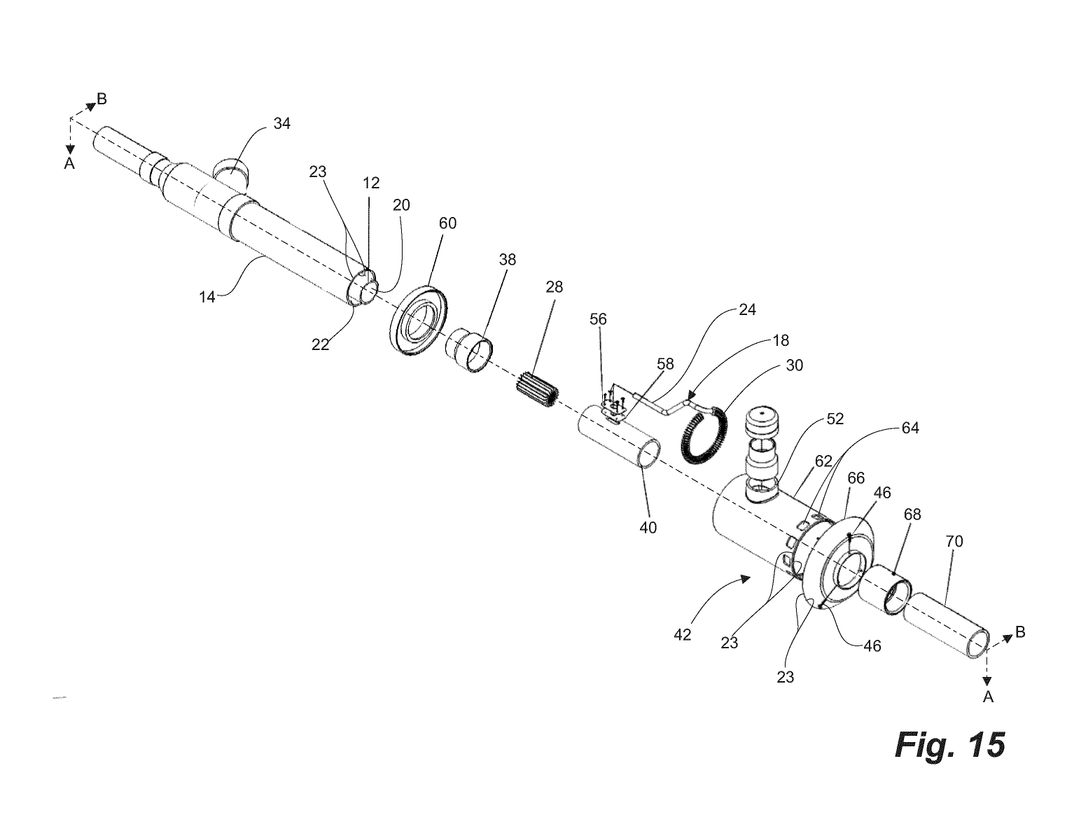

FIG. 15 shows and exploded view of another embodiment of the apparatus disposed on a concentric two-pipe configuration that may be used for vertical installations (e.g., through a roof). The concentric configuration is as described above for the embodiment shown in FIG. 3.

In many respects this embodiment is the same as that shown in FIGS. 3 to 14B. However, the location of the air intake is different, therefore the heat pipe 18 is oriented 180 degrees relative to that shown in FIGS. 11 to 14B. Air intake bracket 36 of the previously described embodiments is not used as a conduit for combustion air, but rather is merely a bracket 60 that centres and holds air intake baffle 42 on the air intake pipe 14. Baffle 42 comprises a housing 62 with openings 64 at its top (distal) end for the entry of combustion air and a cap 66 to protect the openings from the environment. The exhaust vent extends through and past the end 44 of the baffle 42, for example using a connector 68 to connect exhaust vent extender 40 to a second extender 70. The condensing surfaces 23 of this embodiment of the apparatus may include the inside and outside surfaces of the housing 62 near the openings 64, the inside and outside surface of the cap 66 near the openings, and the inside and outside surfaces of the pipe 14, near the opening.

As exhaust gas exits exhaust vent 12, it passes by heat sink 28 which is disposed in the bore of the exhaust vent well away from the terminus of the vent. Heat sink 28 absorbs heat energy and transfers this energy to the evaporator section 24. The energy then passes to condenser section 26 which extends around the exhaust vent extender 40 at the openings 64. The heat energy may be transmitted from the heat dissipater 30 to condensing surfaces 23 directly by contact. Also, combustion air passes through the openings 64 of the housing 62, and across the condenser section 26 where it absorbs the heat energy and it may transfer some of this heat energy to the condensing surfaces. Because the air intake condensing surfaces are heated, the water vapour in the air surrounding the air intake, or in the combustion air, is less likely to condense and form frost on the frost condensing surfaces.

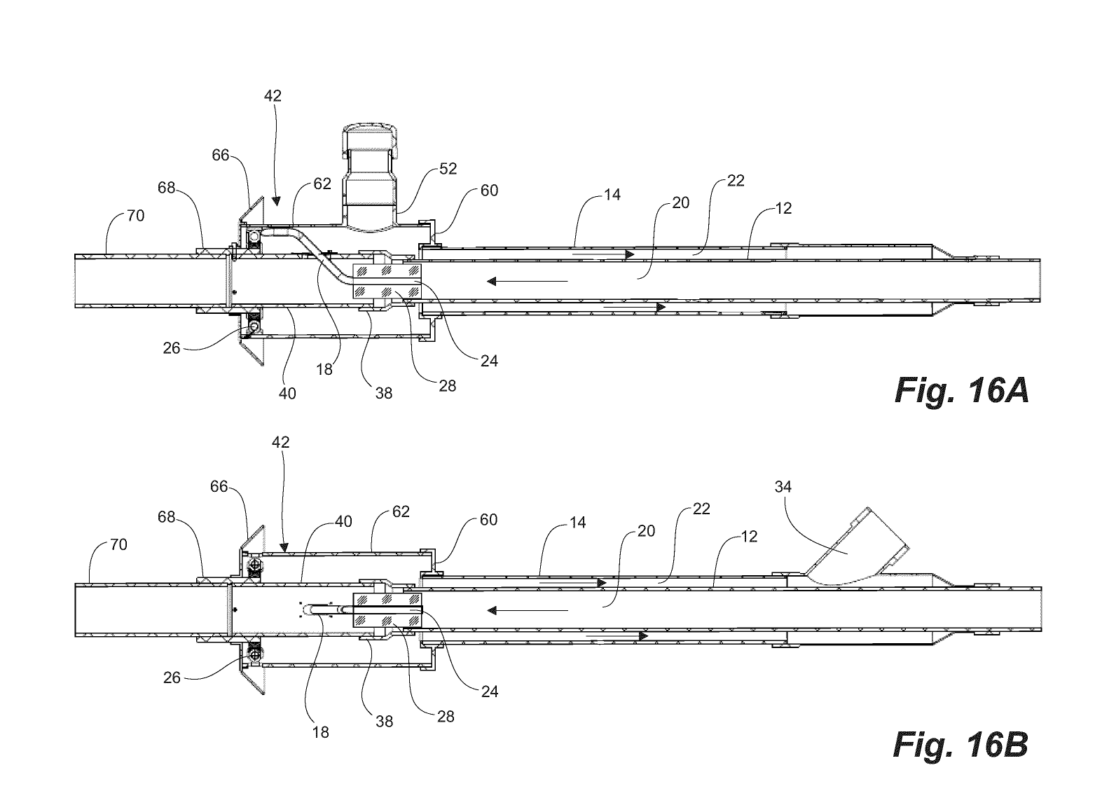

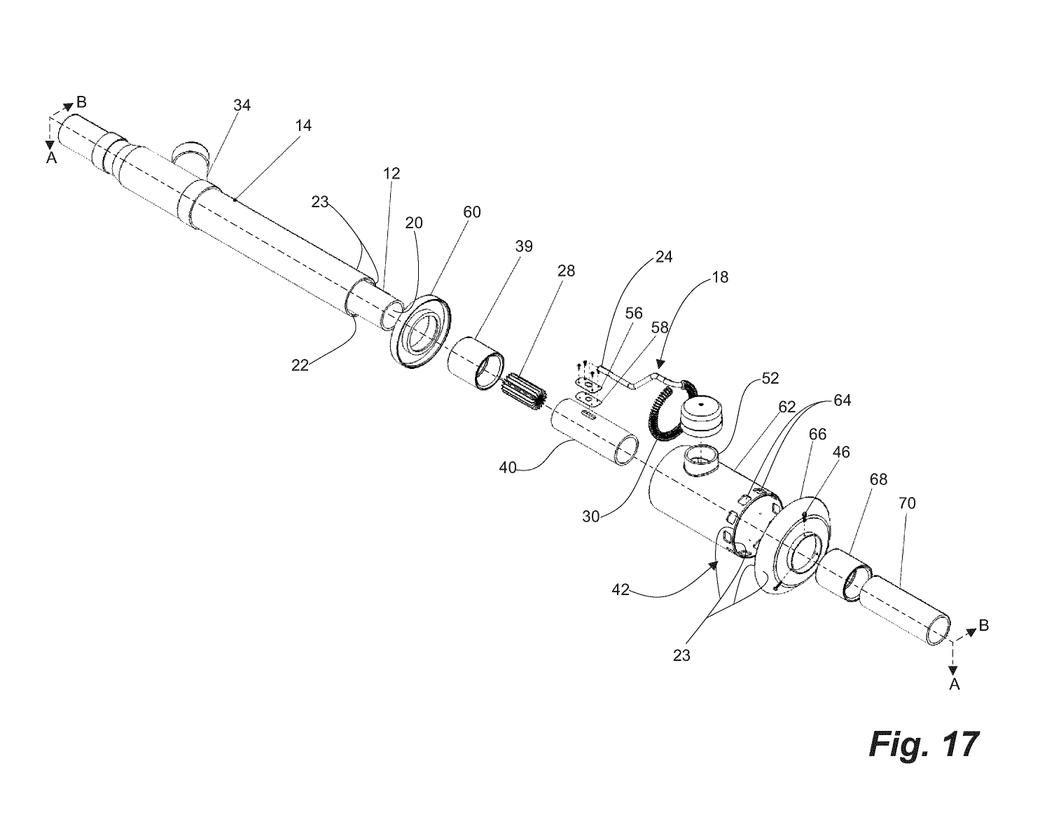

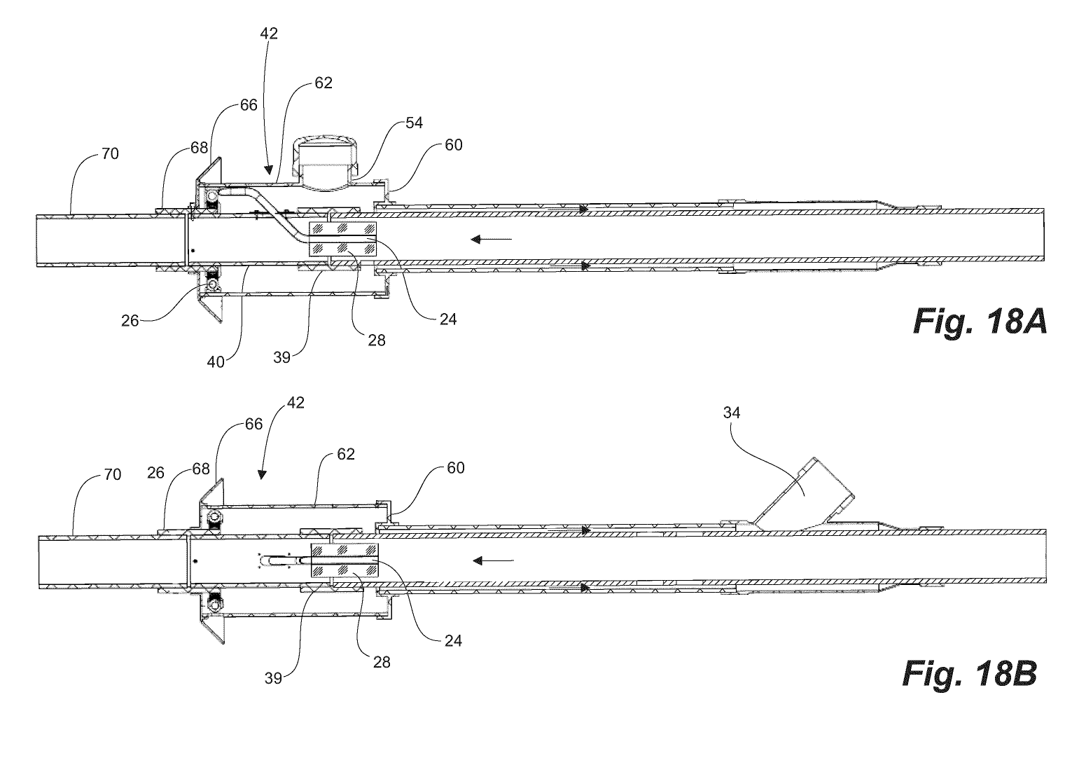

The embodiment shown in FIGS. 17, 18A and 18B is similar to that of FIGS. 15, 16A and 16B except in that the coupling 39 used to couple the exhaust pipe 12 to the exhaust pipe extender 40 is not a reducer coupling. Therefore, in this embodiment there is no increase in cross-sectional area of the exhaust pipe to offset the diameter of the heat pipe.

The embodiments shown in FIGS. 11 to 18B comprise only one lateral port 52 for use to retrofit a side-by-side venting configuration, which has adjacent exhaust gas and air intake conduits. When used on a concentric vent configuration, the lateral port 52 is capped. If the apparatus is used on a side-by-side installation the lateral port 52 is used to fluidly connect the combustion air that is drawn into baffle 42 to the separate air intake pipe.

When used in a side-by-side installation bracket 60 may be modified to slide over and sealably connect to the separate exhaust vent 12. Thus, as compared to the brackets shown in the embodiments of FIGS. 11 to 18B, the inner ring of bracket 60 may have a smaller circumference to fit around the exhaust vent. Alternatively, a reducer coupling or flush bushing may be used to connect the bracket to the exhaust vent.

The exhaust and vent pipes of conventional condensing appliances are commonly made of polyvinylchloride (PVC), chlorinated polyvinylchloride (CPVC) and polypropylene (e.g., PolyPro®). The apparatus described herein may be made with PVC, CPVC or polypropylene piping materials, and it may be used with pipes that are made with PVC, CPVC or polypropylene. In some embodiments the apparatus may be designed to fit onto exhaust and/or air intake pipes having 2-3″ diameter (0-350,000 BTU input appliances), 4″ diameter (350-600,000 BTU input appliances) and 6-8″ diameter (up to 1,000,000 BTU input appliance). It may be used on new installs or to retrofit an existing installation. These three different types of pipe have different maximum operating temperatures and the mode of attachment of the apparatus described herein to these pipes may vary, as is well known by persons of skill in the art. For example, PolyPro is not glued but is gasketed to make a connection between pipes.

### Heat Exchanger Assembly Embodiment

In one embodiment the heat-conducting path 18 is a heat exchanger assembly. The first, or flue gas exchanger, section 24 is a heat-absorbing section of the path and the second, or air-intake exchanger section, 26 is a heat-dissipating section of the path. These two sections are connected by a heat-conducting middle section 27.

The flue gas exchanger section and the air-intake exchanger section are passive heat exchangers that absorb heat from the surrounding environment (on the flue gas side) and that dissipate heat into the surrounding environment (on the air intake side), respectively. They are designed to provide minimal resistance to airflow while at the same time maximizing the amount of heat energy being transferred to or from them. Because exhaust gas is corrosive, the materials for construction are preferably corrosion resistant. They may be made of a metal, an alloy, a resin, a mineral, a heat-conducting polymer, or the like, that has high thermal conductivity, e.g., without limitation copper and aluminum. Preferred for use herein is aluminum and its alloys, and specifically 6063-T6 aluminum alloy.

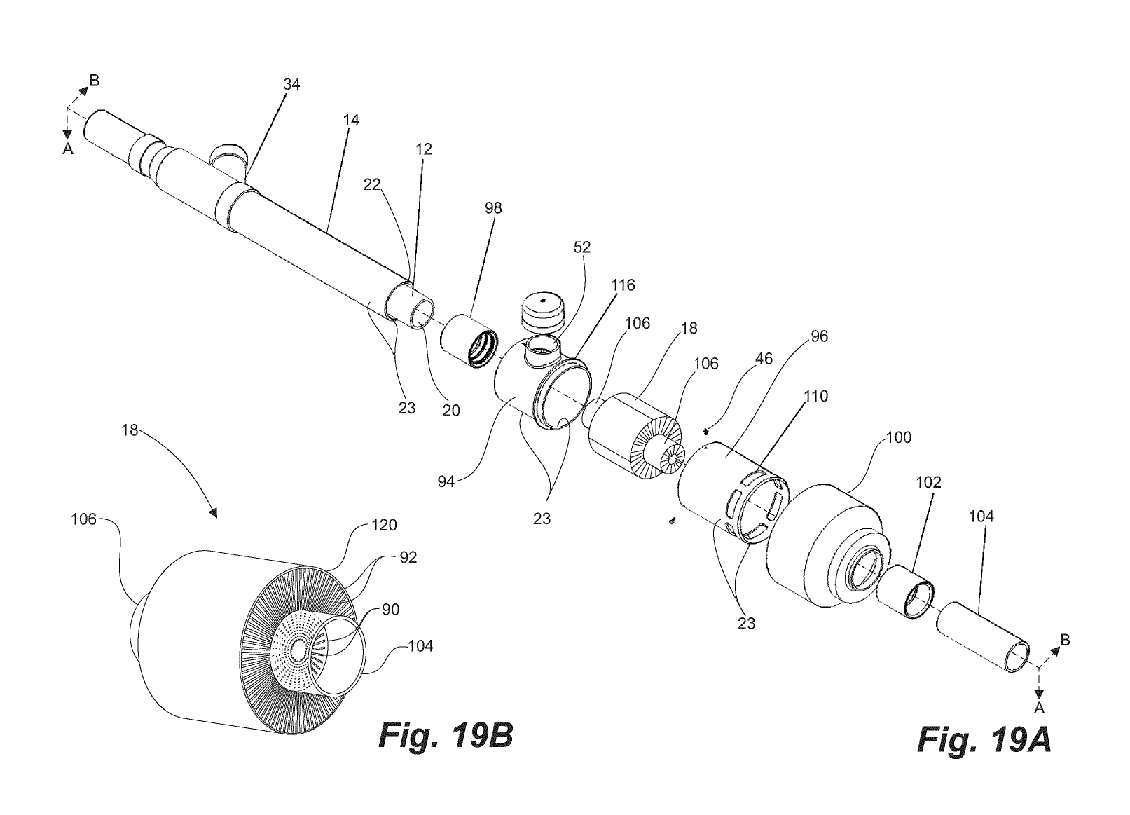

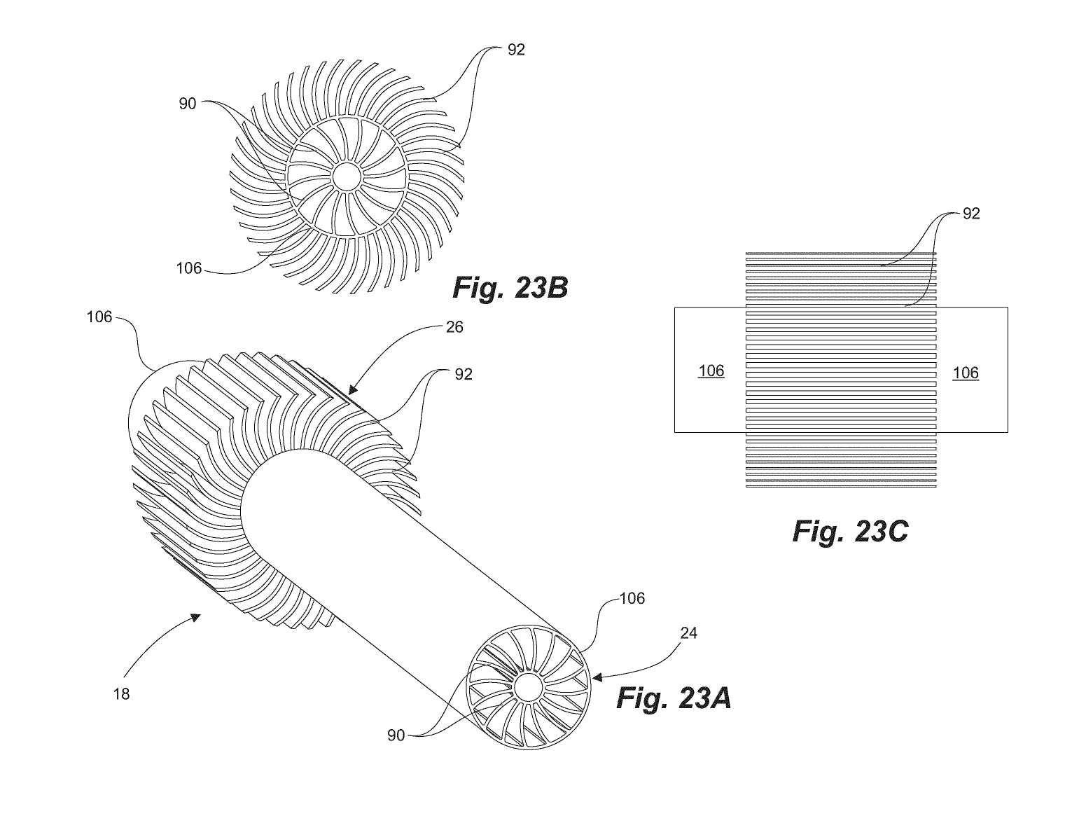

To effectively absorb heat from the exhaust gas and dissipate heat to the frost condensing surfaces of the air intake, the flue gas and air-intake exchangers preferably have fins to allow as much contact as possible with the gas or air passing over them. As seen in an embodiment shown in FIGS. 19 to 24B, both exchangers may have an elongated through channel for receiving a heat pipe therethrough.

Specific embodiments of a heat-conducting path that is an exchanger assembly will now be described in accompanying FIGS. 19A to 24B. These embodiments are designed to be used on a new vertical or horizontal installation of exhaust vents and air intakes, or to retrofit a prior installation.

FIGS. 19A, B and 20A-C show embodiments of the apparatus described herein. FIG. 19A shows an exploded view of an embodiment disposed on a concentric two-pipe configuration that extends through the sidewall of a building. The concentric configuration comprises a conventional exhaust vent or conduit 12 that defines an exhaust gas passageway 20, an air intake pipe or conduit 14 that defines a combustion air passageway 22 around the exhaust vent 12, and a 50° socket tee 34 to direct the stream of combustion air to the appliance.

The embodiment comprises a coupling 98, a bottom air intake housing 94, a top air intake housing 96, a heat-conducting path 18 which is the exchanger assembly, a baffle 100, a second coupling 102 and an exhaust vent extender 104.

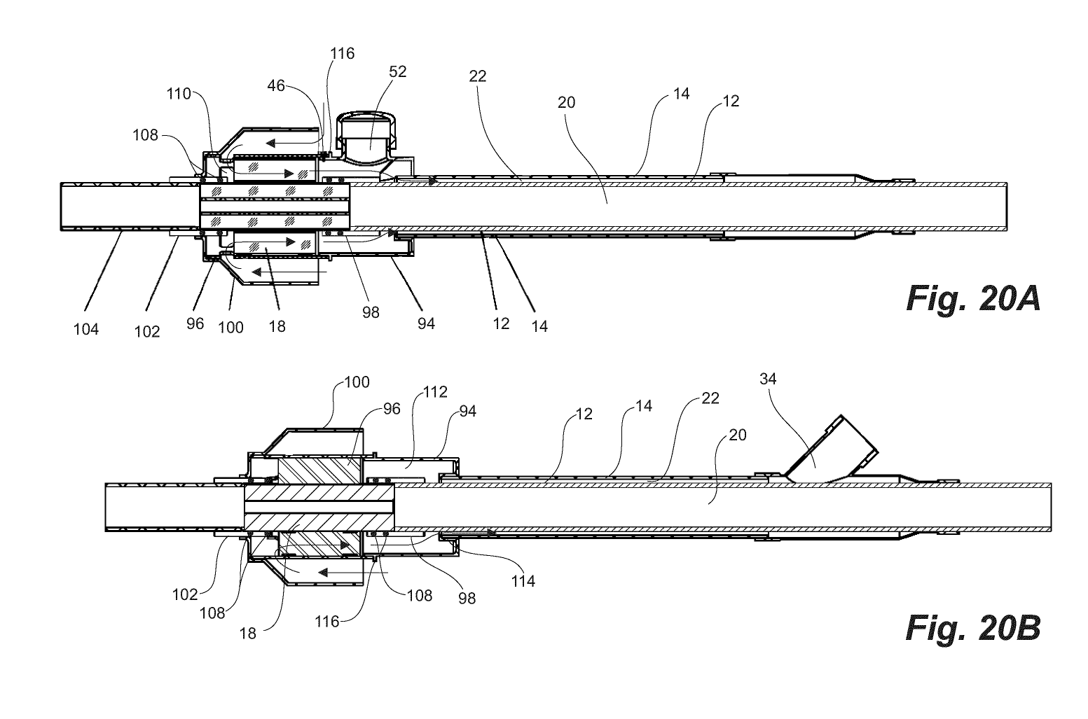

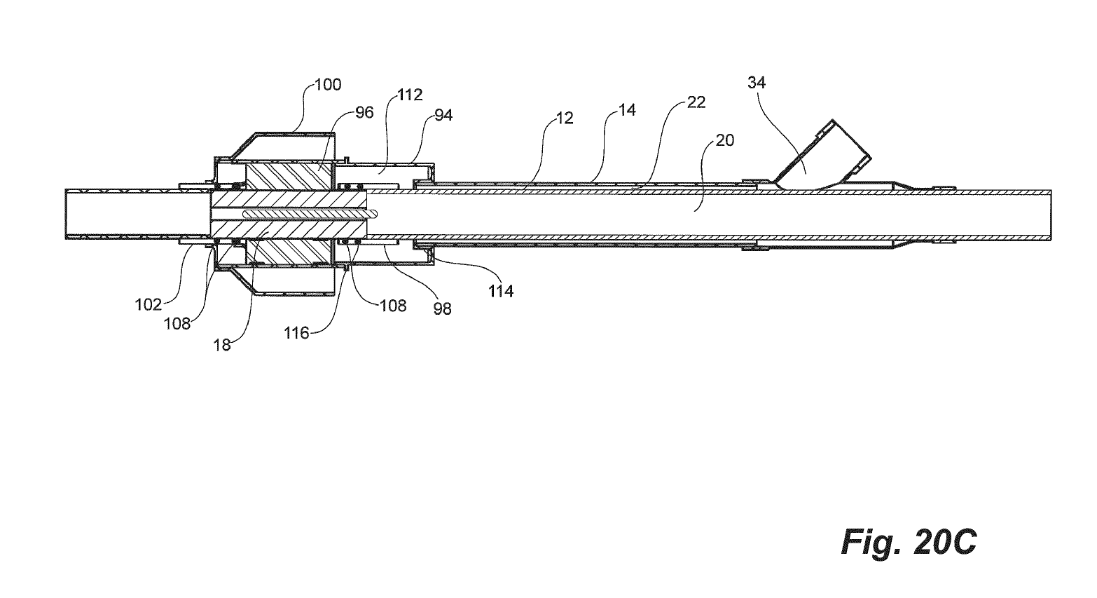

Coupling 98 connects exhaust vent 12 to a first end of an exhaust conduit 106 extending through the heat-conducting path 118. Coupling 102 connects a second end of the exhaust conduit 106 of the heat-conducting path to the exhaust vent extender 104. The connections between the exhaust conduit 106 of the heat-conducting path and the exhaust vent or vent extender are sealed, so that exhaust (flue) gas does not contaminate combustion air drawn into the air intake pipe. This sealing may be accomplished for example by two circumferential O-rings 108 (see FIG. 20) that are disposed on the outside of each end of the exhaust conduit 106. Exhaust conduit 106 and extender 104 extend the exhaust gas vent 12. Thus, a continuous exhaust gas path is formed from the end of the exhaust gas vent 12 that exits a building, through the heat-conducting path and to the outside of the building via the exhaust vent extender 104.

Bottom and top air intake housing, 94 and 96 respectively, are connected to the air intake pipe 14 and extend the combustion air passageway 22 beyond the opening of the air intake pipe. Bottom air intake housing 94 slides over combustion air vent 14 until the combustion air vent abuts stop 114 on the housing, after which the housing is properly positioned and may be affixed to combustion air vent 14, for example by a mechanical seal or by gluing.

Top air intake housing 96 couples with bottom air intake housing 94 by sliding over the end of housing 94 until it abuts rim 116 on housing 94, whereafter the two housings may be connected with set screws 46. The use of set screws enables the removal of the top air intake housing for servicing of the apparatus if needed. Top air intake housing 96 includes a series of openings 110, through which combustion air is drawn. Baffle 100 is coupled to the top air intake housing 96 by sliding it thereon and affixing it, for example by gluing, to the housing. Combustion air (see arrows in FIG. 20A, B) therefore is drawn into the baffle, through openings 110 of the top air intake housing 96, along path 112 formed by the bottom and top air intake housing, and into the air intake pipe 14.

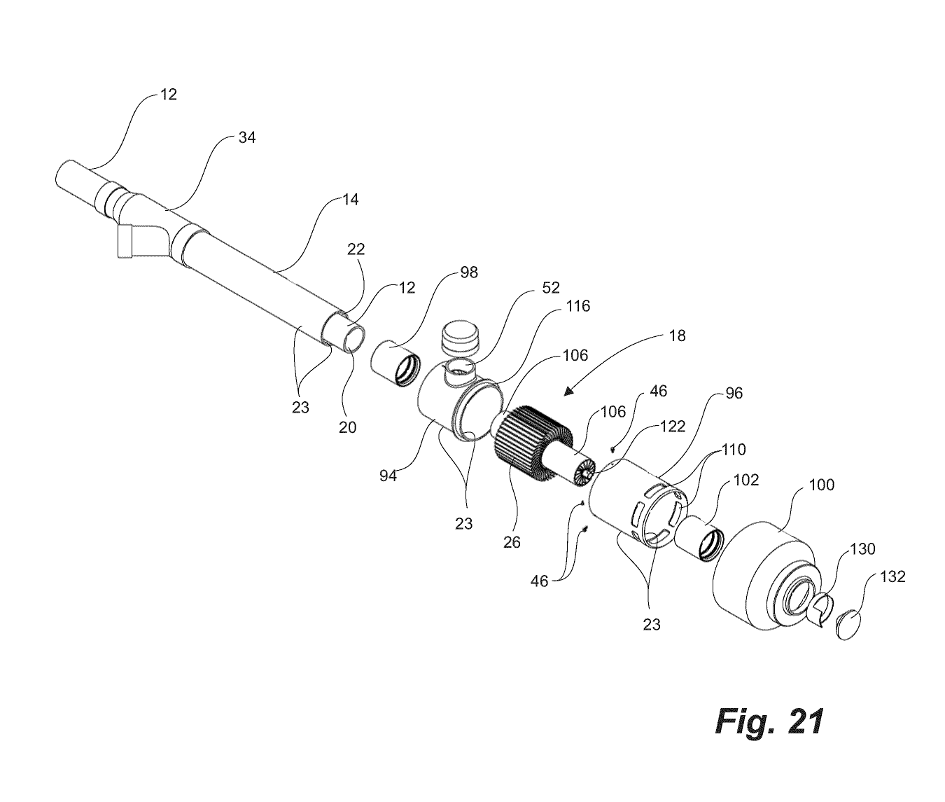

The flue gas exchanger 24 of the heat-conducting path shown in FIGS. 19-23 includes fins 90 which project radially inward from the exhaust conduit 106 towards the centre of the conduit and which extend from the first end to the second end of the conduit. In some embodiments (e.g., FIG. 17B) the fins do not extend along the entire length of the exhaust conduit. Fins 90 may be straight, as shown in FIGS. 19A, B and 20A-C, or curved as shown in FIGS. 21, 22 and 23A-C. Curved fins have a larger surface area than straight fins, and therefore fewer curved fins than straight fins are needed, for the same heat transfer capacity.

As seen in the Figs., the flue gas exchanger may further include an elongated through channel 118 for optionally receiving a heat pipe therein. In other embodiments (not shown) the fins 32 meet at the centre of the flue gas exchanger, and there is no through channel for heat pipe. The fins 32 extract heat energy from the exhaust gas, which is transferred to exhaust conduit 106 (which thermally connects the flue gas exchanger and the air-intake exchanger). Another advantage of this embodiment is that the fins act as a bird screen, to prevent nuisance animals and birds from entering the vent.

Insertion of a heat pipe 122 (see FIG. 21C) into through channel 118 increases the heat transfer capacity of the heat-conducting path, and may be desired in some environments. For example, the heat pipe may be a ¾″ or 1″ diameter heat pipe bringing heat from the bottom portion of the heat-conducting path (closest to the appliance) to the top portion of the heat-conducting path (furthest from the appliance). The heat pipe is thermally connected to the flue gas exchanger (first section) 24 of the heat-conducting path. In other environments heat transfer may be sufficient to heat the frost-condensing surfaces of the combustion air passageway without the need for a heat pipe disposed in the exchanger assembly.

The embodiments of the heat-conducting path shown in FIGS. 19-23 also include an air-intake exchanger 26, which is disposed in the path of the incoming combustion air, in this case in the space 112 between the air intake housing and the exhaust conduit 106 of the heat-conducting path. Like the flue gas exchanger, the air-intake exchanger also includes fins 92 which project radially outward from the exhaust conduit and attach to outer housing 120. Fins 92 may be straight or curved. Outer housing 120 receives heat energy from fins 92 and dissipates this heat energy directly or indirectly to the frost-condensing surfaces. It is designed to be close to, or to touch, the inside surface of bottom and/or top air intake housing, 94 and 96 respectively. Heat energy is therefore transferred from the exhaust conduit 106 along fins 92 to housing 120, thereby directly or indirectly heating the frost condensing surfaces 23 on the air intake pipe or on the bottom and top housing. Some of the heat energy may dissipate from the exhaust conduit 106 or fins 92 to the combustion air, and then to the frost condensing surfaces.

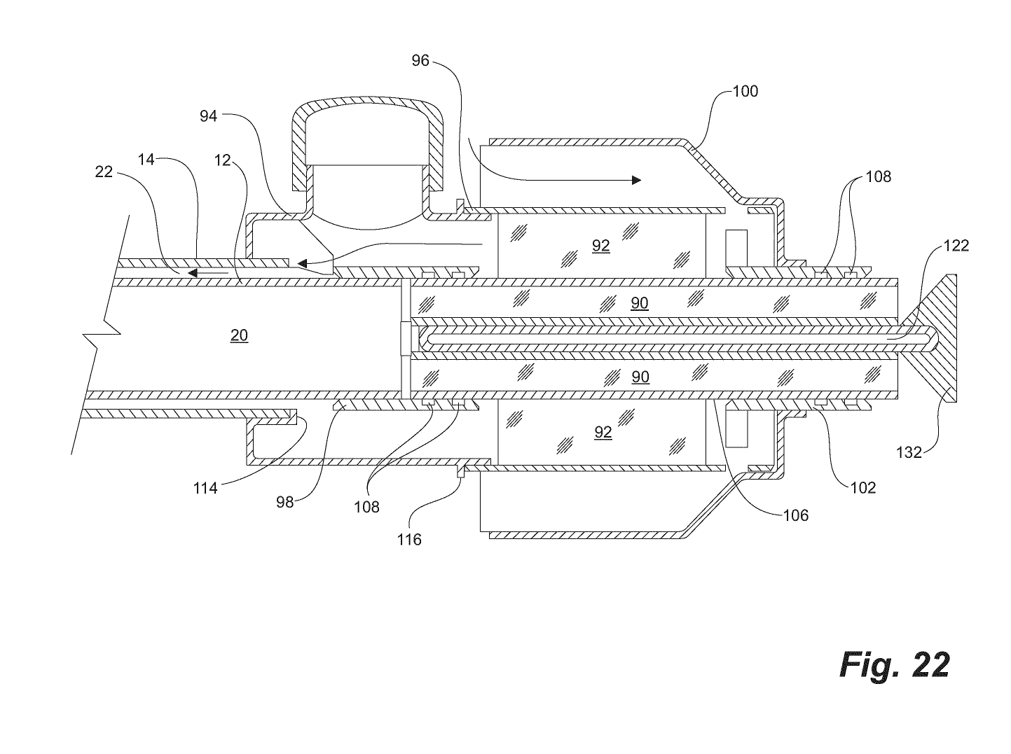

In other embodiments housing 120 is not used (see e.g., FIGS. 21 and 22). Heat energy is therefore transferred from the exhaust conduit 106 along fins 92 thereby directly or indirectly heating the frost condensing surfaces 23 on the air intake pipe or on the bottom and top housing. Some of the heat energy may dissipate from the exhaust conduit 106 or fins 92 to the combustion air, and then to the frost condensing surfaces.

In another embodiment (FIG. 19B) the length of the flue gas exchanger about the same as the length of the air-intake exchanger. As is apparent, the connection of the exhaust conduit 106 of the heat conducting path to the exhaust vent 14 and exhaust vent extender 104 would be different when using this embodiment, as compared to the embodiment of FIGS. 20 to 22, however this modification is well within the skill set of a person of skill in this art.

If the apparatus is used on a side-by-side installation lateral port 52 is used to fluidly connect the combustion air that is drawn into bottom and top air intake housing, 94 and 96 to the separate air intake pipe. The stream of combustion air therefore passes through openings 110 of the top air intake housing 96, and across the air-exchanger assembly, before it exits at port 52 to flow to the separate air intake pipe.

When used in a side-by-side installation bottom air intake housing 94 may also be modified to slide over and sealably connect to the separate exhaust vent 12. Alternatively, a reducer coupling or flush bushing may be used to connect bottom air intake housing 94 to the exhaust vent.

The exchanger assembly or parts thereof may be made of a metal, an alloy, a resin, a mineral, a heat-conducting polymer, or the like, that has high thermal conductivity, e.g., without limitation steel, copper and aluminum. Preferred is aluminum, and particularly 6063-T6 aluminum alloy. It may be made of a flexible material if some range of motion is required.

### Exhaust Vent Icing Prevention Embodiment

Ice can accumulate on the terminus of an exhaust vent, or a redirection fitting of an exhaust vent. When exhaust gas is discharged from the vent of a high efficiency condensing appliance, the gas meets the cold air and condenses, creating moisture that can collect and freeze on surfaces around and inside exhaust vents or a redirection fitting thereon (the “ice-condensing surfaces”). If severe enough, the ice can significantly impede air flow and cause the appliance to shut down.

The heat-conducting path 18 described herein may be modified so that not only does it transfer heat energy from the exhaust gas to the frost-condensing surfaces as described previously, but it also transfers heat energy from the exhaust gas to the terminus of the exhaust vent or a redirecting fitting, places where ice would normally buildup. More particularly, the heat-conducting path transfers heat-energy from the exhaust gas to ice-condensing surfaces on the inside and outside of the vent terminus, or a redirection fitting thereon.

As compared to situation where exhaust gas merely exits the exhaust vent, the heat-conducting path described herein extracts heat from the exhaust gas and directly or indirectly transfers this heat to the ice-condensing surfaces of the exhaust vent terminus, or the redirection fitting if used. The end result is that heat energy is directed to the vent terminus or the redirection fitting, they heat up more, and therefore ice deposition is reduced or eliminated.

An embodiment of the heat conducting path that designed to also prevent ice build-up at the terminus of the exhaust vent or a redirection fitting thereon is show in FIGS. 21 to 24B. Like the embodiment of FIGS. 19 and 20, the heat-conducting path of FIGS. 21 to 24B includes a flue gas exchanger 24, and an air intake exchanger 26. However, the flue gas exchanger 24 is longer and extends to the end of the exhaust vent 12. Exhaust conduit 106 is accordingly longer as well. In this extended portion, rather than transferring heat energy absorbed from the exhaust gas to the air intake exchanger 24, the exhaust conduit 106 will transfer heat energy the ice-condensing surfaces at the terminus of the exhaust vent itself, directly or indirectly.

This embodiment may further include a heat pipe 122 in the heat-conducting path, as shown in FIG. 21, 22A, B, 24A, B. The heat pipe is further capable of extracting heat from the exhaust gas which contacts it, or from the flue gas exchanger, and transmitting this heat energy to the evaporator section of the heat pipe, where it is transferred back to the flue gas exchanger and/or directly to a redirection fitting (in this case a dispersion cone), as shown in these Figs. Thus, the heat-conducting path of this embodiment moves some of the heat energy of the exhaust gases downstream of the frost-condensing surfaces, where the energy will be directly or indirectly transmitted to surfaces where ice would otherwise tend to accumulate.

FIG. 21 shows an exploded view of an embodiment disposed on a concentric two-pipe configuration that extends through the sidewall of a building and is many ways is the same as FIG. 19, with similar parts having similar functions. This embodiment therefore comprises a coupling 98, a bottom air intake housing 94, a top air intake housing 96, a heat-conducting path 18 which is the exchanger assembly, a baffle 100, and a second coupling 102.

Unlike the embodiment of FIG. 19, coupling 102 connects a second end of the exhaust conduit 106 of the heat-conducting path to the baffle 100, and to a dispersion cone support collar 130 which is further connected to a redirection fitting, in this instance a dispersion cone 132. The connections between the exhaust conduit 106 and the exhaust vent or the baffle are sealed, so that exhaust (flue) gas does not contaminate combustion air drawn into the air intake pipe. This sealing may be accomplished for example by two circumferential O-rings 108 (see FIG. 22B) that are disposed on the outside of each end of the exhaust conduit 106.

The flue gas exchanger 24 includes fins 90 which project radially inward towards the centre and which extend from the first end to the second end of the exhaust gas conduit. In this embodiment, curved fins are shown. The air-intake exchanger 26 includes fins 92 which project radially outward from the exhaust conduit however in this embodiment they do not attach to an outer housing 120 of the flue gas exchanger. The fins 92 therefore dissipate heat energy directly or indirectly to the frost-condensing surfaces.

The flue gas exchanger 24 further includes an elongated through channel 118 having a heat pipe 122 therein. Use of a heat pipe increases the heat transfer capacity of the heat conducting path.

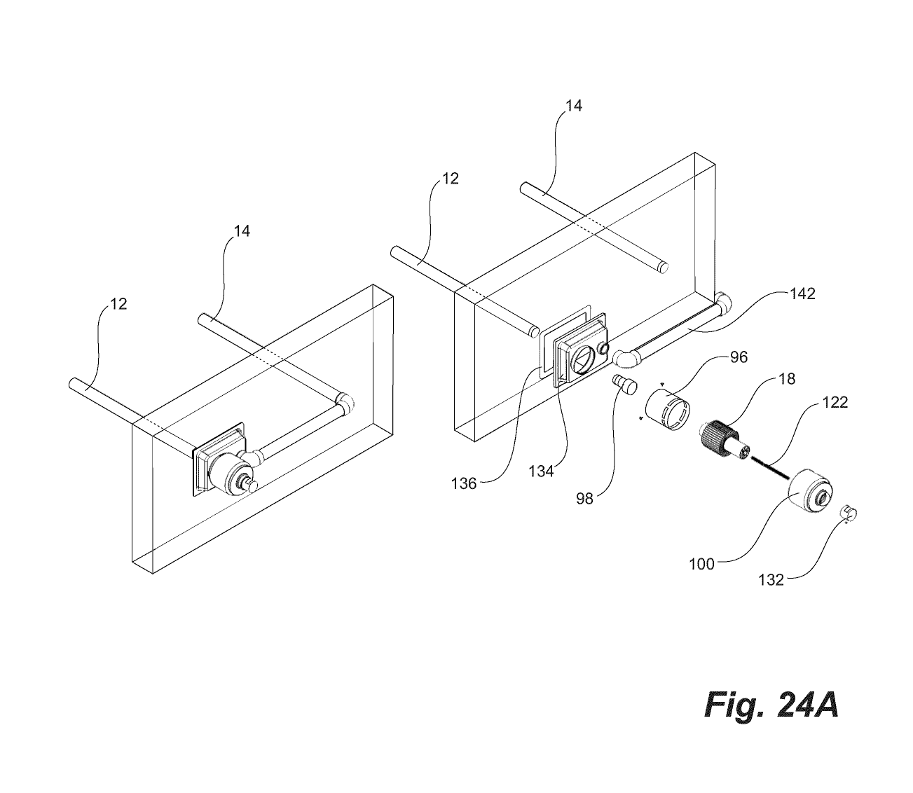

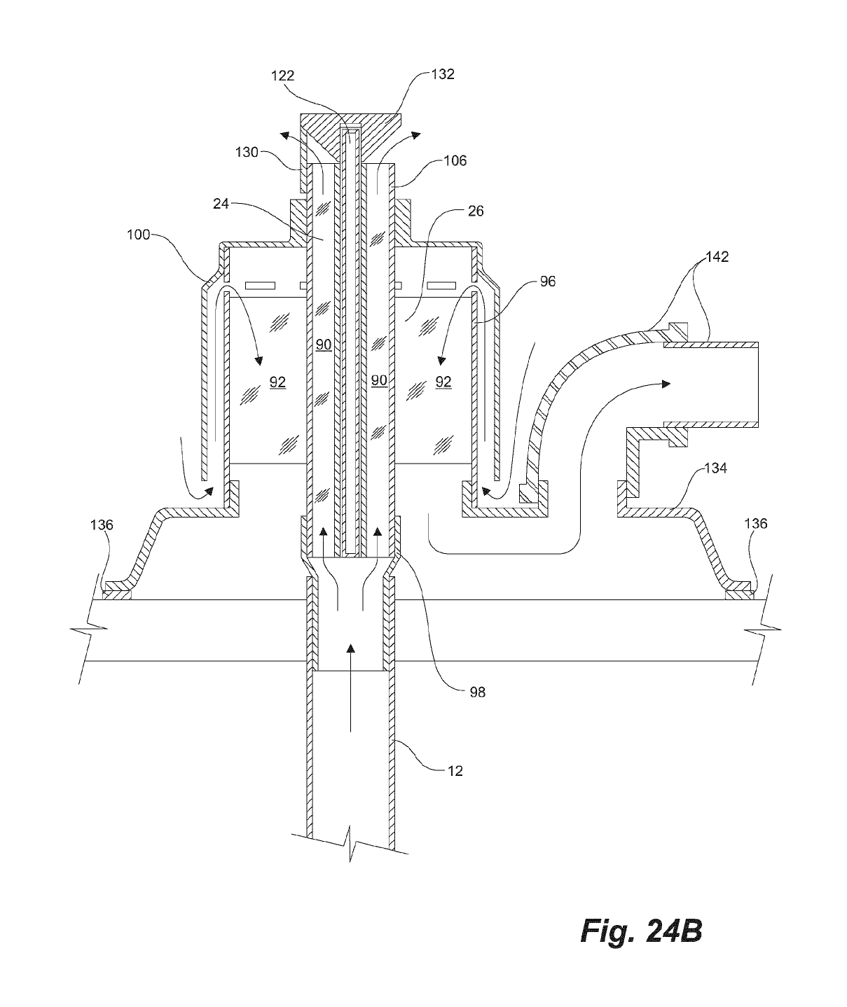

FIG. 24A (right side) shows an exploded view of an embodiment disposed on a side-by-side configuration of an exhaust vent 12 and an air intake pipe 14, that extend through the sidewall of a building. This embodiment comprises a coupling 98, an air intake housing 96, a heat-conducting path 18, a heat pipe 122, a baffle 100 and a dispersion cone 132. This embodiment differs from other embodiments of the apparatus as shown herein in that baffle 100 does not comprise a lateral port 52 for connection to the separate air intake pipe. Rather, this embodiment comprises a plenum 134 which is affixed to the sidewall and sealed thereto using a gasket 136. Plenum 134 has an opening surrounded by a flange 138 that engages baffle 96 (e.g., and a second opening surrounded by a flange 140 that connects to a pipe connector 142 that is connected to air intake pipe 14. As shown in FIG. 24B, combustion air is drawn into the apparatus 10 from the outside, up into the baffle 100 and through openings in the housing 96, across fins 92 of the air-intake exchanger and into the airspace created by the plenum 134, whereafter it enters the pipe connector 142, en route to the air intake pipe 14. All connections are sealed so that exhaust (flue) gas is forced over fins 90 and does not contaminate combustion air drawn into the air intake pipe, and so that combustion air is forced into the air intake pipe.

This sealing may be accomplished for example by two circumferential 0-rings or by gluing, for example.

The exchanger assembly or parts thereof may be made of a metal, an alloy, a resin, a mineral, a heat-conducting polymer, or the like, that has high thermal conductivity, e.g., without limitation steel, copper and aluminum. Preferred is aluminum, and particularly 6063-T6 aluminum alloy. It may be made of a flexible material if some range of motion is required.

A heat-conducting path that avoids ice build-up at the vent terminus and/or redirection fitting may also be constructed from a heat pipe or an assembly of heat-pipes. In this embodiment the heat pipe described in FIGS. 3-18, for example, would be made longer, to extend to the end of the exhaust vent and optionally into any redirection fitting thereon.

### EXAMPLE

Design parameters:

### a) Exhaust gas is 87.8° C. (190° F.)

### b) Inlet Air is −50° C. (−58° F.)

c) Mole fraction of water is 14.53% (53.5° C. Dewpoint)
d) Exhaust Flow Rate is 123.23 m³/hr
e) Inlet Air Flow Rate is 71.69 m³/hr
f) The target is to warm the air a minimum of 15° C. (27° F.)
g) Allowed pressure drop through the inlet and exhaust heat sinks is 0.5″ of water maximum. Heat transfer capacity for the 3-inch design is based upon the parameters described above

While the method and apparatus have been described in conjunction with the disclosed embodiments and examples which are set forth in detail, it should be understood that this is by illustration only and the disclosure is not intended to be limited to these embodiments and examples. On the contrary, this disclosure is intended to cover alternatives, modifications, and equivalents which will become apparent to those skilled in the art in view of this disclosure.

1. An apparatus comprising:
a) an exhaust gas passageway that transports a stream of exhaust gas away from a condenser of a condensing appliance to the outside atmosphere of a building;
b) an air intake opening that transports of a stream of combustion air from the outside atmosphere of the building towards the condensing appliance;
c) a heat-conducting path extending between the exhaust gas and frost condensing surfaces at or near the air intake opening, and said heat-conducting path having a first section for thermal contact with the exhaust gas and a second section for thermal contact with the frost condensing surfaces;
d) said first section comprising a first finned heat exchanger and said second section comprising a second finned heat exchanger, and
e) said heat-conducting path being configured to be capable of the passive transfer of heat energy from the exhaust gas to the frost condensing surfaces.

2. The apparatus of claim 1 wherein the heat-conducting path further comprises one or more heat pipes.

3. The apparatus of claim 2 wherein the first finned heat exchanger is thermally connected to an evaporator section of the heat pipe and the second heat finned exchanger is thermally connected to a condenser section of the heat pipe.

4. The apparatus of claim 1, wherein the heat-conducting path further comprises an exhaust conduit thermally connected on an inside surface to the first finned heat exchanger and thermally connected on an outside surface to the second finned heat exchanger.

5. (canceled)

6. (canceled)

7. The apparatus of claim 1, wherein the heat-conducting path is capable of the passive transfer of heat energy from the exhaust gas to the frost condensing surfaces when the temperature of the exhaust gas is between about 25° C. and 90° C. and the temperature of the combustion air is between about −40° C. and about −10° C.

8. The apparatus of claim 7 wherein the heat-conducting path is capable of the passive transfer of heat energy from the exhaust gas to the frost condensing surfaces when the temperature of the combustion air is between about −30° C. and about −15° C.

9. The apparatus of claim 1 wherein the heat-conducting path further extends between the exhaust gas and the terminus of the exhaust vent, said heat-conducting path being further configured to be capable of the passive transfer of heat energy from the exhaust gas to the ice-condensing surfaces at the terminus of the exhaust vent.

10. The apparatus of claim 9 wherein the heat-conducting path is further configured to be capable of the passive transfer of heat energy from the exhaust gas to the ice-condensing surfaces of a redirection fitting connected to the terminus of the exhaust vent.

11. The apparatus of claim 4 wherein the heat conducting path further comprises one or more heat pipes.

12. The apparatus of claim 1 wherein the first and/or second finned heat exchangers comprise curved fins.

13. A method of avoiding frost buildup on frost condensing surfaces at or near an air intake opening of a condensing appliance, the condensing appliance having an exhaust vent that transports a stream of exhaust gas from the condensing appliance to the outside atmosphere of the building and an air intake pipe that transports a stream of combustion air from the outside atmosphere of the building through the air intake opening to the condensing appliance, the method comprising:
a) disposing a heat-conducting path between the exhaust gas and the frost condensing surfaces, said heat-conducting path having a first section comprising a finned first heat exchanger in thermal contact with the exhaust gas and a second section comprising a second finned heat exchanger in thermal contact with the condensing surfaces; and
b) transferring heat energy from the exhaust gas to the frost condensing surfaces along the heat-conducting path such that the condensing surfaces are heated by the heat energy, thereby avoiding frost buildup at or near the air intake opening.

14. The method of claim 13 wherein the heat-conducting path further comprises one or more heat pipes.

15. The method of claim 14 wherein the first finned heat exchanger is thermally connected to an evaporator section of the heat pipe and the second finned heat exchanger is thermally connected to a condenser section of the heat pipe.

16. The method of claim 13, wherein the heat-conducting path further comprises an exhaust conduit thermally connected on an inside surface to the first finned heat exchanger and thermally connected on an outside surface to the second finned heat exchanger.

17. (canceled)

18. The method of claim 13 wherein the heat-conducting path further extends between the exhaust gas and the terminus of the exhaust vent, said heat-conducting path being further configured to be capable of the passive transfer of heat energy from the exhaust gas to the ice-condensing surfaces at the terminus of the exhaust vent.

19. The method of claim 18 wherein the heat-conducting path is further configured to be capable of the passive transfer of heat energy from the exhaust gas to the ice-condensing surfaces of a redirection fitting connected to the terminus of the exhaust vent.

20. The method of claim 16 wherein the heat-conducting path further comprises one or more heat pipes.

21. (canceled)

22. The method of claim 13, wherein the heat-conducting path transfers heat energy from the exhaust gas to the frost condensing surfaces when the temperature of the exhaust gas is between about 25° C. and 90° C. and the temperature of the combustion air is between about −40° C. and about −10° C.

23. The method of claim 22, wherein the heat-conducting path transfers heat energy from the exhaust gas to the frost condensing surfaces when the temperature of the combustion air is between about −30° C. and about −15° C.

24. The method of claim 13 wherein the first and/or second finned heat exchangers comprise curved fins.

25-30. (canceled)
